(19) United States
(12) Patent Application Publication
(10) Pub. No.: US 2025/0060018 A1
(43) Pub. Date: Feb. 20, 2025

(54) Snubber and Vane Assembly

(71) Applicant: Janox Fluid Power Ltd., Delta (CA)

(72) Inventors: Donald Raymond MARCELLUS, Delta (CA); Jacob BORRELLI, Delta (CA)

(21) Appl. No.: 18/784,829

(22) Filed: Jul. 25, 2024

Related U.S. Application Data
(60) Provisional application No. 63/516,348, filed on Jul. 28, 2023.

(51) Int. Cl. F16F 9/14

(52) U.S. Cl. CPC F16F 9/145; F16F 2222/12; F16F 2230/30; F16F 2232/02; F16F 2236/08

(57) ABSTRACT

A vane assembly and a snubber comprising the same are provided. The vane assembly comprises: a hub for mounting on a shaft of the snubber to rotate with the shaft about a snubber axis, the hub having an inner surface for mounting on the shaft and an outer surface with a vane mounting portion and a dam sealing portion; a vane removably secured to the hub to rotate with the hub about the snubber axis, the vane extending from the hub in a vane-vertical direction and defining at least a distal portion of an outer contour of the vane assembly, the vane having a hub facing surface for mounting to the vane mounting portion of the hub; and a seal assembly for providing a seal between a casing of the snubber and the vane assembly.

### CROSS-REFERENCE TO RELATED APPLICATION

This patent application claims priority to U.S. Provisional Patent Application No. 63/516,348, filed on Jul. 28, 2023 and entitled “SNUBBER AND VANE ASSEMBLY”, the entire contents of which are incorporated herein by reference.

### FIELD

The present disclosure generally relates to dampening and, more particularly, to snubbers and vane assemblies for dampening oscillations in equipment.

### BACKGROUND

Snubbers, also known as dampers or brakes, are commonly used to reduce the amplitude of oscillations in mechanical equipment. Excavators, for example, typically use snubbers to dampen oscillations during regular operation. Dampening oscillations can reduce wear on the excavators, thereby decreasing repair costs. Dampening oscillations can also reduce noise generated by the excavators.

A typical excavator includes a boom with a bucket at the end. The bucket is connected to the boom and controlled by hydraulics, cables, or other known mechanisms. Two common types of excavators are dragline excavators and power shovel excavators. In these excavators, the bucket (also known as a dipper) includes a door that can be selectively opened to drop material from the bucket. During operation, material is scooped into the bucket at an initial location, moved to a new location by the excavator, and then dropped at the new location by opening the door of the bucket.

The door of an excavator's bucket is typically held shut by a latch or other locking mechanism. When the locking mechanism is released, the door swings open and allows material to drop from the bucket under the force of gravity. However, in some instances, the force of gravity on the door and the material in the bucket can cause the door to swing violently open when the locking mechanism is released. This violent motion can cause significant damage and noise, if undampened. Accordingly, a snubber is commonly provided at each rotational end of the door to dampen the swinging motion.

Hydraulic snubbers are a common type of snubber that uses hydraulic fluid to provide an opposing torque to dampen rotational motion. An example of a hydraulic snubber is provided in PCT International Application Publication No. WO 2012/155274 A1. This publication describes a snubber apparatus that includes a casing with an inner cavity, a shaft that passes through the inner cavity, a wiper arm connected to the shaft within the inner cavity, and a dam in close proximity to the wiper arm. The wiper arm rotates with the shaft and displaces hydraulic fluid from one chamber to another within the inner cavity. A hydraulic circuit controls the flow of fluid between the chambers to oppose a rotational force on the shaft and dampen rotational motion of the shaft.

While the contributions of existing snubbers are laudable, improvements and alternatives are generally desired.

### SUMMARY

The following summary is provided to introduce a selection of concepts in simplified form, which are further described below in the detailed description of embodiments. The aspects and embodiments set out in this summary are meant to be exemplary and illustrative. Nothing in this summary is intended to limit the scope of the claimed subject-matter.

In an aspect of the present disclosure, there is provided a vane assembly for a snubber. The vane assembly comprises: a hub for mounting on a shaft of the snubber to rotate with the shaft about a snubber axis, the hub having an inner surface for mounting on the shaft and an outer surface with a vane mounting portion and a dam sealing portion; a vane removably secured to the hub to rotate with the hub about the snubber axis, the vane extending from the hub in a vane-vertical direction and defining at least a distal portion of an outer contour of the vane assembly, the vane having a hub facing surface for mounting to the vane mounting portion of the hub; and a seal assembly for providing a seal between a casing of the snubber and the vaneassembly.

In another aspect of the present disclosure, there is provided a snubber comprising: a casing having an internal cavity; a shaft extending through the casing and into the internal cavity; a vane assembly as defined in the immediately preceding paragraph, wherein the vane assembly is secured on the shaft within the internal cavity to rotate with the shaft about the snubber axis and through a vane-swept region within the internal cavity, wherein the outer contour of the vane assembly generally corresponds to an inner contour of the internal cavity in the vane-swept region, and wherein the seal assembly provides a seal between the vane assembly and the casing; and a dam secured to the casing within the internal cavity and engaging the dam sealing portion of the hub of the vane assembly, such that the dam and the vane assembly divide the internal cavity into a first pressure chamber and an opposing second pressure chamber, wherein a fluid control passage is provided between the first pressure chamber and the second pressure chamber, to control fluid flow between the first and second pressure chambers as the vane assembly rotates.

In another broad aspect, there is provided a vane assembly for a snubber, the vane assembly comprising: a hub for mounting on a shaft of the snubber to rotate with the shaft about a snubber axis, the hub having an inner surface for mounting on the shaft and an outer surface with a vane mounting portion and a dam sealing portion; a vane removably secured to the hub to rotate with the hub about the snubber axis, the vane extending from the hub in a vane-vertical direction and defining at least a distal portion of an outer contour of the vane assembly, the vane having a hub facing surface for mounting to the vane mounting portion of the hub; and a seal assembly for providing a seal between a casing of the snubber and the vane assembly.

In some embodiments, the vane comprises a pedestal removably secured to the hub and a nose removably secured to the pedestal opposite the hub.

In some embodiments, the pedestal comprises the hub facing surface and a nose facing surface, opposite the hub facing surface, and wherein the nose facing surface comprises a nose reinforcing feature that is configured to reinforce the nose when the nose is secured to the pedestal.

In some embodiments, the nose reinforcing feature comprises a pedestal protrusion that extends from the nose facing surface of the pedestal, the pedestal protrusion being sized to fit within a pocket in the nose and to extend radially beyond a centroid of the nose when the nose is secured to the pedestal.

In some embodiments, the nose reinforcing feature comprises a nose key receiving pocket in the nose facing surface of the pedestal and a nose reinforcing key, the nose reinforcing key being sized to fit within the nose key receiving pocket and to extend from the nose key receiving pocket into a different pocket in the nose, the nose reinforcing key extending radially beyond a centroid of the nose when the nose is secured to the pedestal.

In some embodiments, the pedestal and the nose are formed from dissimilar materials.

In some embodiments, the nose comprises at least part of the distal portion of the outer contour in an end region of the nose, and wherein the end region of the nose can be completely machined, including any channels therein, by an uninterrupted sequence of nose turning operations without removing the nose from a lathe performing the nose turning operations.

In some embodiments, the nose comprises at least part of the distal portion of the outer contour in an end region of the nose, and wherein the end region, including any channels therein, is entirely defined by a plurality of coaxial vane circular arcs each at a respective axial and radial depth.

In some embodiments, the nose is secured to the pedestal by at least one nose fastener, and wherein each of the nose fasteners is oriented generally parallel to the vane-vertical direction.

In some embodiments, each of the nose fasteners is concealed within the pedestal and the nose, when the nose is secured to the pedestal and the pedestal is secured to the hub, such that the nose fasteners are not openly exposed to an environment surrounding the vane assembly.

In some embodiments, each of the nose fasteners is oriented oppositely to vane fasteners securing the vane to the hub.

In some embodiments, the nose is secured to the pedestal by a dovetail joint between the nose facing surface of the pedestal and a pedestal facing surface of the nose.

In some embodiments, a dovetail of the dovetail joint between the nose and the pedestal is oriented generally parallel to the snubber axis.

In some embodiments, the vane mounting portion of the hub comprises a vane reinforcing feature that is configured to reinforce the vane when the vane is secured to the hub.

In some embodiments, the vane reinforcing feature comprises a hub protrusion that extends from the vane mounting portion of the hub, the hub protrusion being sized to fit within a pocket in the vane and to extend radially beyond a centroid of the vane when the vane is secured to the hub.

In some embodiments, the vane reinforcing features comprises a vane key receiving pocket in the vane mounting portion of the hub and a vane reinforcing key, the vane reinforcing key being sized to fit within the vane key receiving pocket and to extend from the vane key receiving pocket into a different pocket in the vane, the vane reinforcing key extending radially beyond a centroid of the vane when the vane is secured to the hub.

In some embodiments, the hub comprises a pressure conduit that extends from a pressure inlet to a pressure outlet in a seal channel of the hub, the pressure conduit allowing flow from the pressure inlet to the pressure outlet to pressurize at least a portion of the seal channel.

In some embodiments, the vane assembly further comprises a conduit flow control device configured to restrict reverse flow in the pressure conduit from the pressure outlet to the pressure inlet.

In some embodiments, the conduit flow control device is a check valve provided along the pressure conduit between the pressure inlet and the pressure outlet.

In some embodiments, the pressure inlet is located in the outer surface of the hub, outside of the vane mounting portion.

In some embodiments, the pressure inlet is located in a transition portion of the outer surface of the hub between the vane mounting portion and the dam sealing portion.

In some embodiments, the pressure outlet is located in the seal channel outside of an exclusion region that extends between a pair of vertical planes, each of the vertical planes passing through a respective circumferential terminal edge of the vane mounting portion and extending in the vane-vertical direction and in the direction of the snubber axis.

In some embodiments, the dam sealing portion of the outer surface defines a dam-sweep angle, and wherein the exclusion region further extends circumferentially about the dam-sweep angle between a pair of planar bounds, each of the planar bounds beginning at the snubber axis and extending radially outward from the snubber axis through a respective circumferential terminal edge of the dam sealing portion.

In some embodiments, the dam-sweep angle is in the range of 75 to 135 degrees.

In some embodiments, the seal assembly comprises: a first axial seal region that surrounds the snubber axis at a first axial end of the vane assembly, to provide a seal between the first axial end and the casing of the snubber; a second axial seal region that surround the snubber axis at a second axial end of the vane assembly, opposite the first axial end, to provide a seal between the second axial end and the casing of the snubber; and a vane seal region that extends from the first axial seal region to the second axial seal region and follows the distal portion of the outer contour, to provide a seal between at least the distal portion and the casing of the snubber.

In some embodiments, at least one of the first and second axial seal regions is a pressure-boosted seal region or a mixed seal region, and wherein the vane seal region is a pressure-energized seal region.

In some embodiments, the seal assembly comprises: a first end primary cap seal having a first closed-loop portion and a first tail portion that extends radially outward from the first closed-loop portion, wherein the first closed-loop portion is received within a first end closed-loop channel of the vane assembly for sealing between at least the hub and the casing of the snubber, and wherein the first tail portion is received within a vane channel of the vane assembly for sealing between the vane and the casing of the snubber; a second primary end cap seal having a second closed-loop portion and a second tail portion that extends radially outward from the second closed-loop portion, wherein the second closed-loop portion is received within a second end closed-loop channel of the vane assembly for sealing between at least the hub and the casing of the snubber, the second end closed-loop channel being located axially opposite the first end closed-loop channel, and wherein the second tail portion is received within the vane channel for sealing between the vane and the casing of the snubber; and a distal cap seal that is received within the vane channel and extends from the first tail portion to the second tail portion for sealing between the distal portion and the casing of th snubber.

In some embodiments, the first closed loop-portion and the second closed-loop portion are each complete closed circles.

In some embodiments, the hub defines a hub portion of at least one of the first and second closed-loop channels, and wherein the hub portion terminates at the vane mounting portion of the hub.

In some embodiments, the vane defines a vane portion of the at least one of the first and second closed-loop channels, and wherein the hub portion and the vane portion cooperate to define the at least one of the first and second closed-loop channels when the vane is secured to the vane mounting portion of the hub, such that the vane mounting portion defines a boundary between the hub portion and the vane portion.

In some embodiments, the seal assembly comprises a first end outer energizing seal and a first end inner energizing seal that both underly the first end primary cap seal, and wherein an enclosed portion of the first closed-loop channel is configured to be pressurized, the enclosed portion being defined between the first end primary cap seal, the first end outer energizing seal, the first end inner energizing seal and the hub.

In some embodiments, the seal assembly comprises a second end outer energizing seal and a second end inner energizing seal that both underly the second end primary cap seal, and wherein an enclosed portion of the second closed-loop channel is configured to be pressurized, the enclosed portion being defined between the second end primary cap seal, the second end outer energizing seal, the second end inner energizing seal and the hub.

In some embodiments, the shape of each of the outer energizing seals is substantially similar to the shape of the respective overlying cap seal.

In some embodiments, each of the cap seals is formed from a rigid, wear resistant material, and each of the energizing seals is formed from a resiliently elastic material that is different from the rigid, wear resistant material.

In some embodiments, the seal assembly comprise a distal energizing seal that underlies the distal cap seal.

In some embodiments, the seal assembly comprises at least one secondary cap seal, each of which is circumferentially surrounded by a respective one of the first and second closed-loop portions and is received within a respective secondary seal channel in the hub, for providing additional sealing between the hub and the casing of the snubber.

In some embodiments, the seal assembly comprises a respective secondary energizing seal underlying each of the secondary cap seals.

In some embodiments, the vane assembly comprises only a single vane channel.

In some embodiments, the vane channel is entirely formed in the vane and does not extend into the hub of the vane assembly.

In some embodiments, the first end primary cap seal and the second end primary cap seal are each substantially flat.

In some embodiments, the first end primary cap seal and the second end primary cap seal are coupled to the distal cap seal by lap joints and/or bridle joints.

In some embodiments, the hub defines a maximum radius that is set by the dam sealing portion of the outer surface, and wherein the vane mounting portion is entirely contained within the maximum radius of the hub.

In some embodiments, the vane mounting portion is entirely located between the maximum radius of the hub and a vane mounting plane that is defined by an innermost surface of the vane mounting portion.

In some embodiments, the vane mounting plane is spaced apart from the snubber axis in the vane-vertical direction by between 65% and 95% of the maximum radius of the hub, and preferably by about 85% of the maximum radius.

In some embodiments, the hub comprises a pair of axially opposed end surfaces, and wherein the dam sealing portion and one of the end surfaces of the hub can be completely machined, including any channels therein, by an uninterrupted sequence of hub turning operations without removing the hub from a lathe performing the hub turning operations.

In some embodiments, the hub comprises a pair of axially opposed end surfaces, and wherein the dam sealing portion and one of the end surfaces, including any channels therein, are entirely defined by a plurality of circular arcs that are all coaxial and are each defined at a respective axial position and radial depth or a respective radial position and axial depth.

In some embodiments, the vane includes a vane portion of the outer contour, and wherein the vane portion extends from one axial edge of the vane to an opposite axial edge of the vane, and includes the distal portion of the outer contour.

In some embodiments, the vane portion of the outer contour is substantially square and comprises a flat tip portion that connects two opposing, straight vane-vertical portions of the outer contour.

In some embodiments, the vane comprises at least one chamfer surface adjacent a distal tip of the vane.

In some embodiments, the vane is secured to the hub by a plurality of vane fasteners, and wherein each of the vane fasteners is oriented generally parallel to the vane-vertical direction.

In some embodiments, the vane fasteners are received through bores in the vane, and wherein none of the bores extend through the vane in a generally circumferential direction of the vane.

In some embodiments, the vane is secured to the hub by a dovetail joint between the hub facing surface of the vane and the vane mounting portion of the hub.

In some embodiments, a dovetail of the dovetail joint between the vane and the hub is oriented generally parallel to the snubber axis.

In some embodiments, the vane assembly further comprises at least one of a mechanical seal and a sealing adhesive between the hub facing surface of the vane and the vane mounting portion of the hub.

In another broad aspect, there is provided a snubber comprising: a casing having an internal cavity; a shaft extending through the casing and into the internal cavity; a vane assembly as described above, wherein the vane assembly is secured on the shaft within the internal cavity to rotate with the shaft about the snubber axis and through a vane-swept region within the internal cavity, wherein the outer contour of the vane assembly generally corresponds to an inner contour of the internal cavity in the vane-swept region, and wherein the seal assembly provides a seal between the vane assembly and the casing; and a dam secured to the casing within the internal cavity and engaging the dam sealing portion of the hub of the vane assembly, such that the dam and the vane assembly divide the internal cavity into a first pressure chamber and an opposing second pressure chamber, wherein a fluid control passage is provided between the first pressure chamber and the second pressure chamber, to control fluid flow between the first and second pressure chambers as the vane assembly rotates.

In some embodiments, the snubber further comprises an adjustable control device in fluid communication with the fluid control passage to adjust flow in the fluid control passage.

In some embodiments, the adjustable control devices is an adjustable valve that is accessible from an outside of the casing.

In some embodiments, the snubber further comprises an accumulator in fluid communication with the fluid control passage and housed within the casing.

In some embodiments, the snubber further comprises one or more displacement bodies secured within the internal cavity of the casing and positioned outside the vane-swept region to reduce an amount of fluid required to fill the first and second pressure chambers.

In some embodiments, the displacement bodies occupy up to 100% of the volume of the first and second pressure chambers outside of the sweep region.

In some embodiments, the one or more displacement bodies comprises a first displacement body secured within the first pressure chamber and a second displacement body secured within the second pressure chamber.

In some embodiments, the one or more displacement bodies are all substantially the same shape and, preferably, a generally kidney shape.

In some embodiments, the snubber further comprises an accumulator in fluid communication with the internal cavity, the accumulator being housed completely within the casing.

In another broad aspect, there is provided a snubber comprising: a casing having an internal cavity; a shaft extending through the casing and into the internal cavity; a vane assembly secured on the shaft within the internal cavity to rotate with the shaft about the snubber axis and through a vane-swept region within the internal cavity; a dam secured to the casing within the internal cavity and engaging the vane assembly such that the dam and the vane assembly divide the internal cavity into a first pressure chamber and a second pressure chamber; and an accumulator in fluid communication with the internal cavity, the accumulator housed completely within the casing.

In some embodiments, the accumulator comprises an accumulator cavity having a volume, and a flexible diaphragm separating the volume into a liquid side and a gas side.

In some embodiments, the gas side of the accumulator cavity volume is configured to hold compressed gas.

In some embodiments, the accumulator comprises an accumulator cavity having a volume, and a piston mechanically biased to reduce the volume.

In some embodiments, the shaft rotates about a snubber axis, and wherein the snubber axis extends through the accumulator cavity.

In some embodiments, the snubber axis extends through the center of the accumulator cavity.

In some embodiments, the accumulator is in fluid communication with the internal cavity via a flow path that includes at least one flow control device.

In some embodiments, the at least one flow control device comprises a scavenge oil check valve.

In another broad aspect, there is provided a vane assembly for a snubber, the vane assembly comprising: a hub for mounting on a shaft of the snubber to rotate with the shaft about a snubber axis, the hub having an inner surface for mounting on the shaft and an outer surface with a vane extending radially outwardly from the outer surface; and a seal assembly for providing a seal between a casing of the snubber and the vane assembly.

In some embodiments, the hub comprises a pressure conduit that extends from a pressure inlet to a pressure outlet in a seal channel of the hub, the pressure conduit allowing flow from the pressure inlet to the pressure outlet to pressurize at least a portion of the seal channel.

In some embodiments, the vane assembly further comprises a conduit flow control device configured to restrict reverse flow in the pressure conduit from the pressure outlet to the pressure inlet.

In some embodiments, the pressure inlet is located on the outer surface of the hub.

In some embodiments, the seal assembly comprises: a first axial seal region that surrounds the snubber axis at a first axial end of the vane assembly, to provide a seal between the first axial end and the casing of the snubber; a second axial seal region that surrounds the snubber axis at a second axial end of the vane assembly, to provide a seal between the second axial end and the casing of the snubber; and a vane seal region that extends from the first axial seal region to the second axial seal region and follows an outer contour of a distal portion of the vane, to provide a seal between the distal portion of the vane and the casing of the snubber.

In some embodiments, at least one of the first and second axial seal regions is a pressure-boosted seal region or is a mixed seal region, and wherein the vane seal region is a pressure-energized seal region.

In some embodiments, the seal assembly comprises: a first end primary cap seal having a first closed-loop portion and a first tail portion that extends radially outward from the first closed-loop portion, wherein the first closed-loop portion is received within a first end closed-loop channel of the vane assembly for sealing between at least the hub and the casing of the snubber, and wherein the first tail portion is received within a vane channel of the vane assembly for sealing between the vane and the casing of the snubber; a second primary end cap seal having a second closed-loop portion and a second tail portion that extends radially outward from the second closed-loop portion, wherein the second closed-loop portion is received within a second end closed-loop channel of the vane assembly for sealing between at least the hub and the casing of the snubber, the second end closed-loop channel being located axially opposite the first end closed-loop channel, and wherein the second tail portion is received within the vane channel for sealing between the vane and the casing of the snubber; and a distal cap seal that is received within the vane channel and extends from the first tail portion to the second tail portion for sealing between the distal portion and the casing of th snubber.

In some embodiments, the seal assembly comprises a first end outer seal energizer and a first end inner seal energizer that each underly the first end primary cap seal, and wherein an enclosed portion of the first closed-loop channel is configured to be pressurized, the enclosed portion being defined between the first end primary cap seal, the first end outer seal energizer, the first end inner seal energizer, and the hub.

In some embodiments, the seal assembly comprises a second end outer seal energizer and a second end inner seal energizer that each underly the second end primary cap seal, and wherein an enclosed portion of the second closed-loop channel is configured to be pressurized, the enclosed portion being defined between the second end primary cap seal, the second end outer seal energizer, the second end inner seal energizer, and the hub.

In some embodiments, each of the cap seals is formed from a rigid, wear resistant material, and each of the seal energizers is formed from a resiliently elastic material that is different from the rigid, wear resistant material.

In some embodiments, the seal assembly comprise a distal seal energizer that underlies the distal cap seal.

In some embodiments, the seal assembly comprises at least one secondary cap seal, each of which is circumferentially surrounded by a respective one of the first and second closed-loop portions and is received within a respective secondary seal channel in the hub, for providing additional sealing between the hub and the casing of the snubber.

In some embodiments, the seal assembly comprises a respective secondary seal energizer underlying each of the secondary cap seals.

In some embodiments, the first end primary cap seal and the second end primary cap seal are each substantially flat.

In accordance with another broad aspect, there is provided a snubber comprising: a casing having an internal cavity; a shaft extending through the casing and into the internal cavity; a vane assembly as described above, wherein the vane assembly is secured on the shaft within the internal cavity to rotate with the shaft about the snubber axis and through a vane-swept region within the internal cavity, wherein the outer contour of the vane assembly generally corresponds to an inner contour of the internal cavity in the vane-swept region, and wherein the seal assembly provides a seal between the vane assembly and the casing; and a dam secured to the casing within the internal cavity and engaging the dam sealing portion of the hub of the vane assembly, such that the dam and the vane assembly divide the internal cavity into a first pressure chamber and an opposing second pressure chamber, wherein a fluid control passage is provided between the first pressure chamber and the second pressure chamber, to control fluid flow between the first and second pressure chambers as the vane assembly rotates.

In accordance with another broad aspect, there is provided a vane assembly for a snubber, the vane assembly comprising: a hub for mounting on a shaft of the snubber to rotate with the shaft about a snubber axis, the hub having an inner surface for mounting on the shaft and an outer surface with a vane extending radially outwardly from the outer surface, wherein the hub comprises a pressure conduit that extends from a pressure inlet located on the outer surface of the hub to a pressure outlet in a seal channel of the hub, the pressure conduit allowing flow from an internal cavity of the snubber to the pressure outlet to pressurize an enclosed portion of the seal channel; and a seal assembly for providing a seal between a casing of the snubber and the vane assembly, wherein the seal assembly comprises: a cap seal received within the seal channel of the hub for sealing between at least the hub and the casing of the snubber; and an outer seal energizer and an inner seal energizer that are each positioned within the seal channel and underly the cap seal; wherein the enclosed portion of the seal channel is bounded by the cap seal, the outer seal energizer, the inner seal energizer, and an inner surface of the seal channel.

In some embodiments, the vane assembly further comprises a conduit flow control device configured to restrict reverse flow in the pressure conduit from the pressure outlet to the pressure inlet.

In some embodiments, the hub further comprises a second pressure conduit that extends from a second pressure inlet to a second pressure outlet in the seal channel of the hub, the second pressure inlet located on the outer surface of the hub on the opposing side of the vane as the pressure inlet, the second pressure conduit allowing flow from the internal cavity of the snubber to the pressure outlet to pressurize the enclosed portion of the seal channel.

In some embodiments, the vane assembly further comprises a second conduit flow control device configured to restrict reverse flow in the pressure conduit from the second pressure outlet to the second pressure inlet.

In some embodiments, each of the cap seals is formed from a rigid, wear resistant material, and each of the seal energizers is formed from a resiliently elastic material that is different from the rigid, wear resistant material.

In accordance with another broad aspect, there is provided a snubber comprising: a casing having an internal cavity; a shaft extending through the casing and into the internal cavity; a vane assembly as described above, wherein the vane assembly is secured on the shaft within the internal cavity to rotate with the shaft about the snubber axis and through a vane-swept region within the internal cavity, wherein the outer contour of the vane assembly generally corresponds to an inner contour of the internal cavity in the vane-swept region, and wherein the seal assembly provides a seal between the vane assembly and the casing; and a dam secured to the casing within the internal cavity and engaging the dam sealing portion of the hub of the vane assembly, such that the dam and the vane assembly divide the internal cavity into a first pressure chamber and an opposing second pressure chamber, wherein a fluid control passage is provided between the first pressure chamber and the second pressure chamber, to control fluid flow between the first and second pressure chambers as the vane assembly rotates.

### BRIEF DESCRIPTION OF THE DRAWINGS

Embodiments will now be described more fully with reference to the accompanying drawings, in which:

FIG. 1 is an isometric view of an embodiment of a snubber;

FIG. 2 is an exploded view of the snubber of FIG. 1;

FIG. 3 is a front view of the snubber of FIG. 1;

FIG. 4 is a side view of the snubber of FIG. 1;

FIG. 5 is a sectional view of the snubber of FIG. 1, taken along line 5-5 of FIG. 3;

FIG. 6 is a sectional view of the snubber of FIG. 1, taken along line 6-6 of FIG. 4;

FIG. 7 is a sectional view of the snubber of FIG. 1, taken along line 7-7 of FIG. 4;

FIG. 8 is an isometric view of a vane assembly of the snubber of FIG. 1;

FIG. 9 is an exploded view of the vane assembly of FIG. 8;

FIG. 10 is a front view of the vane assembly of FIG. 8;

FIG. 11 is a sectional view of the vane assembly of FIG. 8, taken along line 11-11 of FIG. 10;

FIG. 12 is a sectional view of the vane assembly of FIG. 8, taken along line 12-12 of FIG. 10;

FIG. 13 is an isometric view of the vane assembly of FIG. 8, with seal and fastener elements omitted;

FIG. 14 is a front view of the vane assembly of FIG. 8, with the seal and fastener elements omitted;

FIG. 15 is a top view of a hub of the vane assembly of FIG. 8;

FIG. 16 is a front view of the hub of the vane assembly of FIG. 8;

FIG. 17 is a top view of a vane of the vane assembly of FIG. 8;

FIG. 18 is a front view of the vane of the vane assembly of FIG. 8;

FIG. 19 is a side view of the vane of the vane assembly of FIG. 8;

FIG. 20 is a bottom view of the vane of the vane assembly of FIG. 8;

FIG. 21 is an isometric view of another embodiment of a vane assembly;

FIG. 22 is an exploded view of the vane assembly of FIG. 21;

FIG. 23 is a front view of the vane assembly of FIG. 21;

FIG. 24 is a sectional view of the vane assembly of FIG. 21, taken along line 24-24 of FIG. 23;

FIG. 25 is a sectional view of the vane assembly of FIG. 21, taken along line 25-25 of FIG. 23;

FIG. 26 is an enlarged detail view of the vane assembly of FIG. 21, showing detail 26 of FIG. 25;

FIG. 27 is an isometric view of the vane assembly of FIG. 21, with seal and fastener elements omitted;

FIG. 28 is a top view of the vane assembly of FIG. 21, with the seal and fastener elements omitted;

FIG. 29 is a front view of the vane assembly of FIG. 21, with the seal and fastener elements omitted;

FIG. 30 is a top view of a hub of the vane assembly of FIG. 21;

FIG. 31 is a front view of the hub of the vane assembly of FIG. 21;

FIG. 32 is a top view of a pedestal of the vane assembly of FIG. 21;

FIG. 33 is a front view of the pedestal of the vane assembly of FIG. 21;

FIG. 34 is a side view of the pedestal of the vane assembly of FIG. 21;

FIG. 35 is a bottom view of the pedestal of the vane assembly of FIG. 21;

FIG. 36 is a top view of a nose of the vane assembly of FIG. 21;

FIG. 37 is a front view of the nose of the vane assembly of FIG. 21;

FIG. 38 is a side view of the nose of the vane assembly of FIG. 21;

FIG. 39 is a bottom view of the nose of the vane assembly of FIG. 21;

FIG. 40 is an exploded view of another embodiment of a snubber;

FIG. 41 is a side view of the snubber of FIG. 40;

FIG. 42 is a sectional view of the snubber of FIG. 40, taken along line 42-42 in FIG. 41;

FIG. 43 is a front view of the snubber of FIG. 40;

FIG. 44 is a sectional view of the snubber of FIG. 40, taken along line 44-44 in FIG. 43; and

FIG. 45 is a sectional view of the snubber of FIG. 40, taken along line 45-45 in FIG. 43.

### DETAILED DESCRIPTION OF EMBODIMENTS

This detailed description of embodiments, and the foregoing summary, will be better understood when interpreted in conjunction with the accompanying drawings.

As used herein, an element described in the singular and preceded by the word “a” or “an” should be understood as not necessarily excluding a plural of the elements. Further, references to “an example”, “an embodiment”, “one example”, or “one embodiment” with a described element are not intended to exclude the existence of additional examples or embodiments with the described element. Moreover, unless explicitly stated to the contrary, examples or embodiments “comprising”, “having”, “with”, or “including” an element that has a particular property may further include additional elements not having that particular property. Additionally, references to “an example” or “an embodiment” herein may refer to the same example or embodiment, but do not necessarily refer to the same example or embodiment.

As used herein, it will be understood that the terms “comprises”, “has”, “with”, and “includes” all mean “including but not limited to” and the terms “comprising”, “having”, and “including” have equivalent meaning. Additionally, it will be understood that lists ending with the term “and/or” include any and all combinations of one or more of the listed elements.

It will be understood that when an element is referred to as being “on”, “attached”, “connected”, “coupled”, or similarly engaged to another element, that element may be directly or indirectly on, attached, connected, or coupled to the other element. However, when an element is referred to as being “directly on”, “directly attached”, “directly connected”, “directly coupled”, “contacting”, or similarly engaged to another element, there are no intermediate elements between that element and the other element. It will be similarly understood that when an element is referred to as being “proximally on”, “proximally attached”, “proximally connected”, “proximally coupled”, or similarly engaged to another element, those elements are engaged with a limited number of elements therebetween, such as a single element therebetween. It will be further understood that elements which are integrally formed may be referred to as being “on”, “attached”, “connected”, “coupled” or similarly engaged (including the “directly” and “proximally” variants thereof). However, elements referred to as being “separably”, “detachably”, “selectively”, “removably”, or similarly coupled are not integrally formed.

It will be understood that spatially relative terms, such as “under”, “below”, “lower”, “over”, “above”, “upper”, “front”, “back”, and the like, may be used herein for ease of describing the relationship of one element to another as depicted in the figures. However, elements described with spatially relative terms may encompass different orientations in use or operation, in addition to the orientation depicted in the figures and described herein.

Unless otherwise indicated, the terms “first”, “second”, etc. are used herein merely as labels, and are not intended to impose ordinal, positional, or hierarchical requirements on the items to which these terms refer. Additionally, reference to a “second” item does not require or preclude the existence of a lower-numbered item (e.g., a “first” item) and/or a higher-numbered item (e.g., a “third” item).

As used herein, the terms “approximately” and “about” represent an amount close to the recited amount that still performs the desired function or achieves the desired result. For example, the terms “approximately” and “about” can refer to an amount that is within engineering tolerances that would be readily appreciated by a person of ordinary skill in the art.

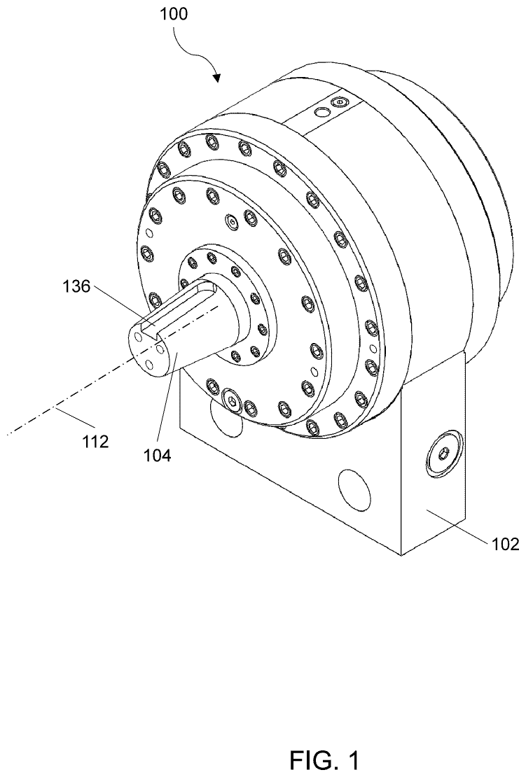

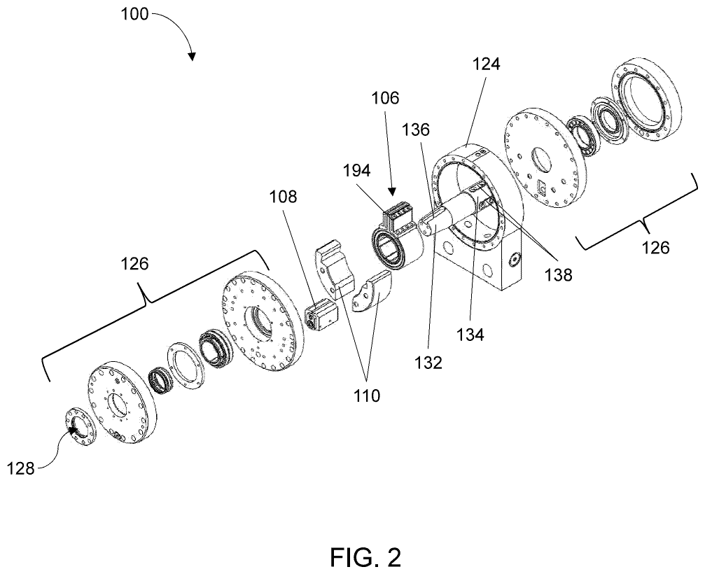

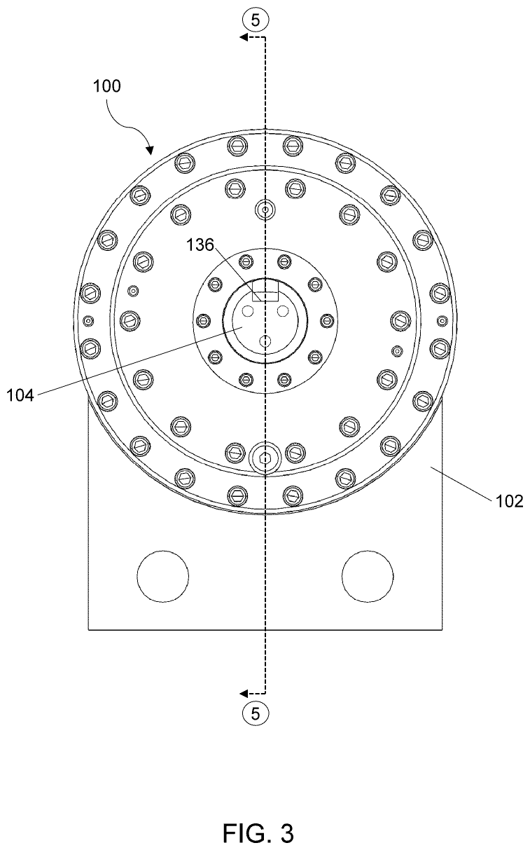

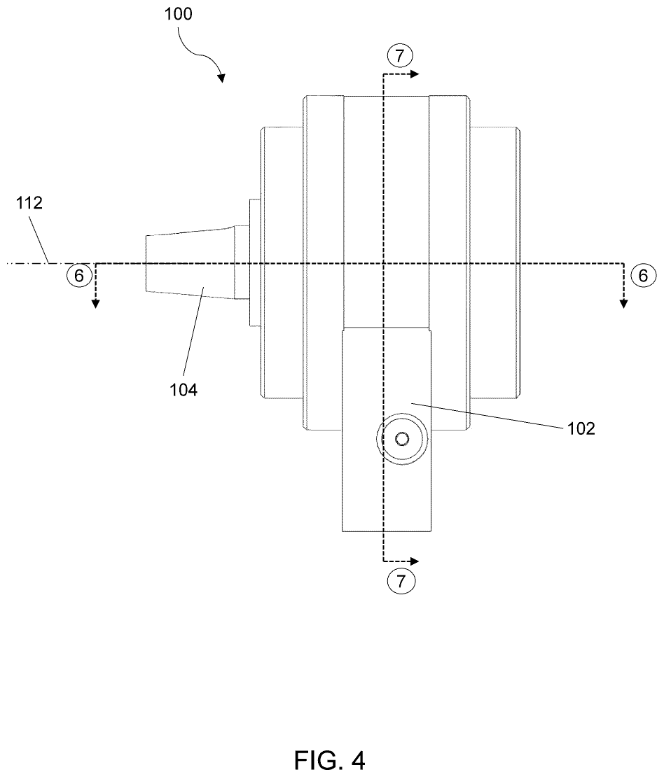

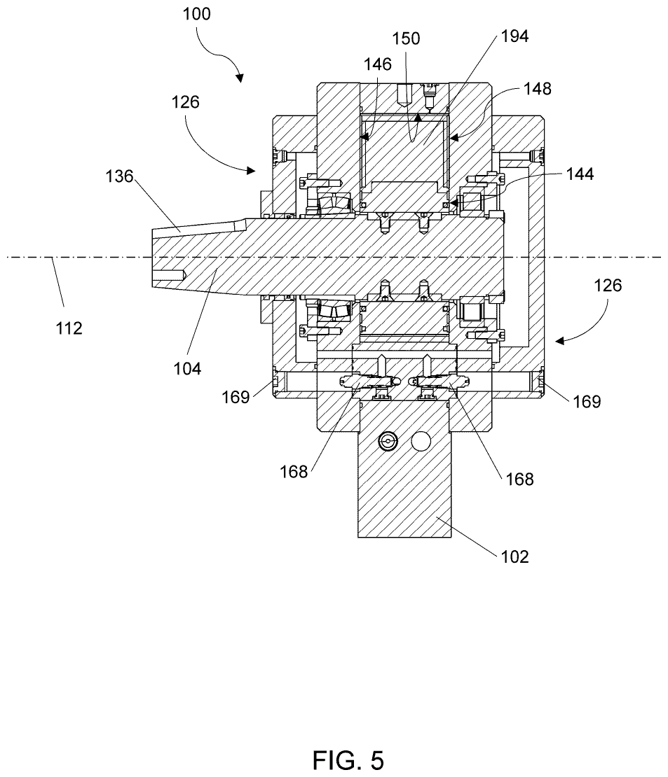

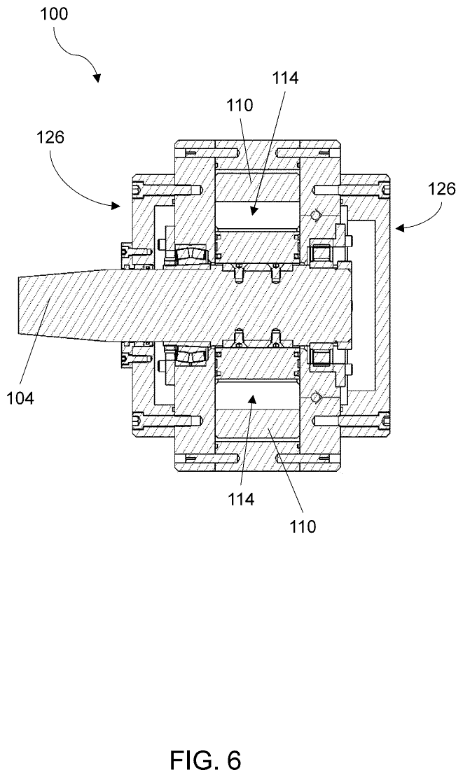

FIGS. 1 to 7 show an embodiment of a snubber that is generally identified by reference character 100. The snubber 100 is configured to be used with equipment to dampen rotational motion of one or more parts of the equipment. For example, the snubber 100 may be provided at one or at each end of a door of an excavator to dampen swinging motion of the door.

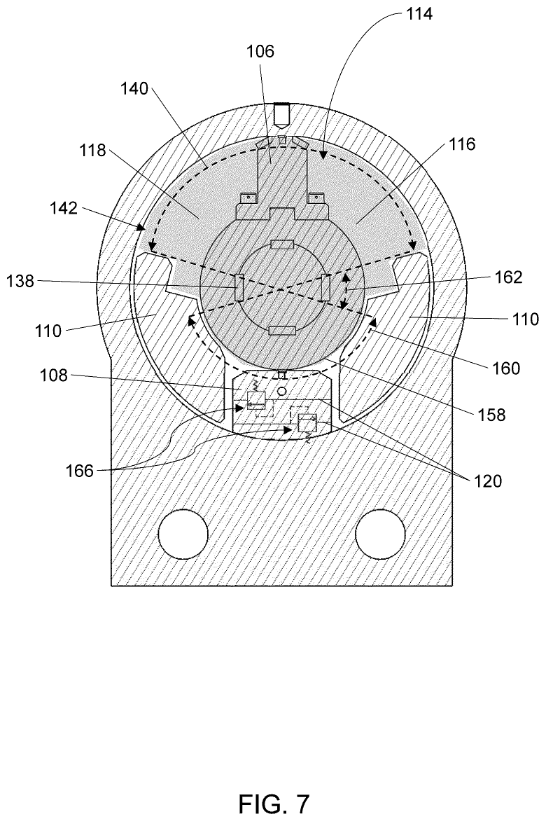

The snubber 100 comprises a casing 102, a shaft 104, a vane assembly 106, and a dam 108. Optionally, the snubber 100 further comprises one or more displacement bodies 110. The snubber 100 has a snubber axis 112. The casing 102 defines an internal cavity 114. The shaft 104 extends through the casing 102 into the internal cavity 114. The vane assembly 106 is secured to the shaft 104 and rotates with the shaft 104. The dam 108 engages the vane assembly 106 to divide the internal cavity 114 into a first pressure chamber 116 and a second pressure chamber 118 (shown in e.g. FIG. 7). In use, the shaft 104 is coupled to a rotatable part, such as a door on a bucket of an excavator, and rotates with the part. As the shaft 104 rotates, the vane assembly 106 displaces a fluid, more specifically a liquid such as oil, within the casing 102 from the first pressure chamber 116 to the second pressure chamber 118 (or vice versa) through at least one fluid control passage 120. Displacing the fluid generates a torque on the vane assembly 106. That torque is transmitted to the rotating part via the shaft 104, to provide dampening for the rotational motion of the part. The elements and operation of the snubber 100 are described in greater detail below.

The casing 102 of the snubber 100 is configured to be secured to the equipment by conventional means, such as by fasteners. The casing 102 supports the other elements of the snubber 100. The casing 102 comprises a casing body 124 and a pair of end assemblies 126. The end assemblies 126 are coupled to the casing body 124 at opposite ends thereof and, together with the casing body 124, define the internal cavity 114 of the casing 102. During use, the internal cavity 114 of the snubber is filled with a fluid, more specifically a liquid such as oil. Appropriate seals are provided between the casing body 124 and the end assemblies 126, such as O-rings or other known seals, so that the fluid within the internal cavity 114 does not leak out of the casing 102. At least one of the end assemblies 126 includes an opening 128 for the shaft 104 to pass through, such that the shaft 104 can extend from outside the casing 102 to within the internal cavity 114. Optionally, one or both of the end assemblies 126 may comprise bearings to support the shaft 104. The bearings may help to reduce friction as the shaft 104 rotates relative to the casing 102.

The shaft 104 is configured to be coupled to a rotatable part (not shown), such as a door of a bucket on an excavator. The shaft 104 rotates about the snubber axis 112. The shaft 104 rotates with the rotatable part during operation and transmits that rotation to the vane assembly 106. Accordingly, the shaft 104 includes an external portion 132 for coupling to the part and an internal portion 134 for coupling to the vane assembly 106. The external portion 132 and the internal portion 134 can each include keyways, keys, splines, and/or other mechanisms for transferring rotational motion, as is known in the art. In the subject embodiment, the external portion 132 of the shaft 104 includes a keyway 136 that is sized to mesh with a key of the rotatable part. In the subject embodiment, the internal portion 134 of the shaft 104 includes a plurality of keys 138 that are sized to mesh with keyways of the vane assembly 106 (see e.g. FIG. 7).

The vane assembly 106 is configured to rotate with the shaft 104. As such, the vane assembly 106 is secured on the shaft 104. In the subject embodiment, the vane assembly 106 is mounted on the internal portion 134 of the shaft 104, within the internal cavity 114, and is rotationally secured to the shaft 104 via the keys 138 on the internal portion 134. In other embodiments, the vane assembly 106 may be secured to the shaft by other suitable mechanisms, such as by splines or fasteners. When in use, the vane assembly 106 rotates about the snubber axis 112 of the snubber 100, within the internal cavity 114 of the casing 102. The vane assembly 106 rotates through a vane-sweep angle 140 within the internal cavity 114. The area the vane assembly 106 occupies as it passes through the vane-sweep angle 140 is defined as the vane-swept region 142 (see FIG. 7).

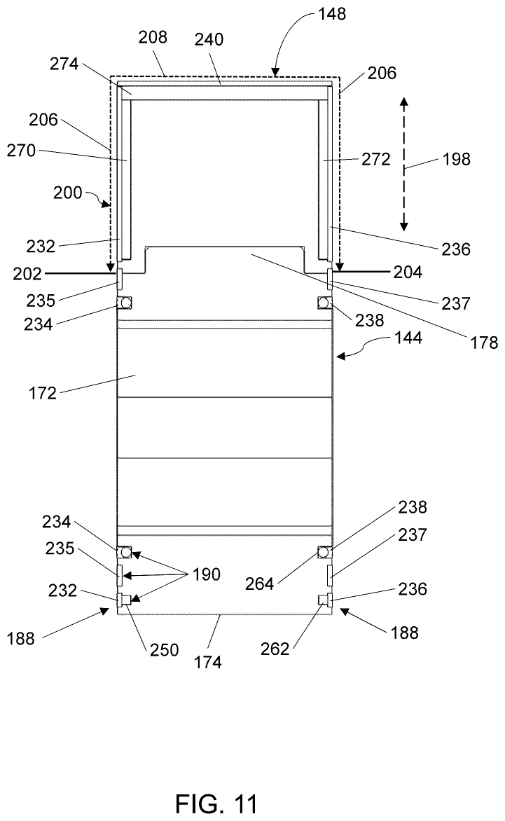

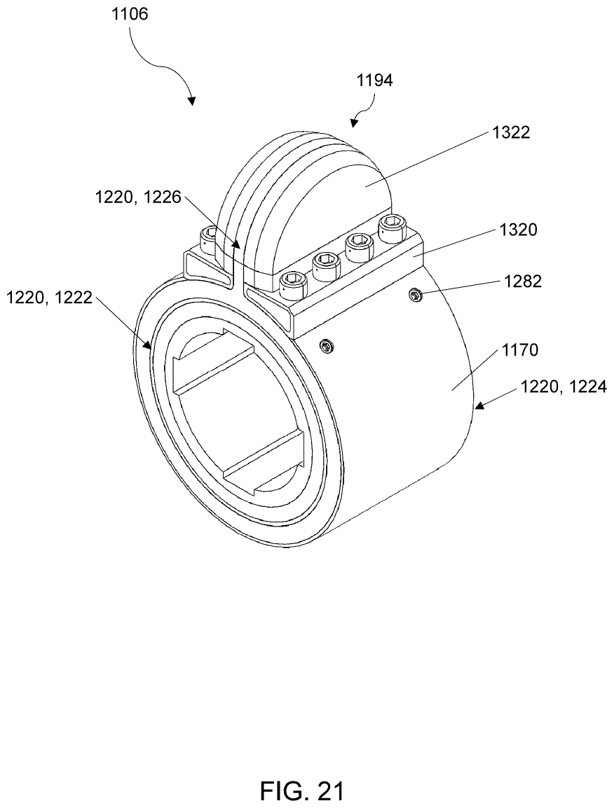

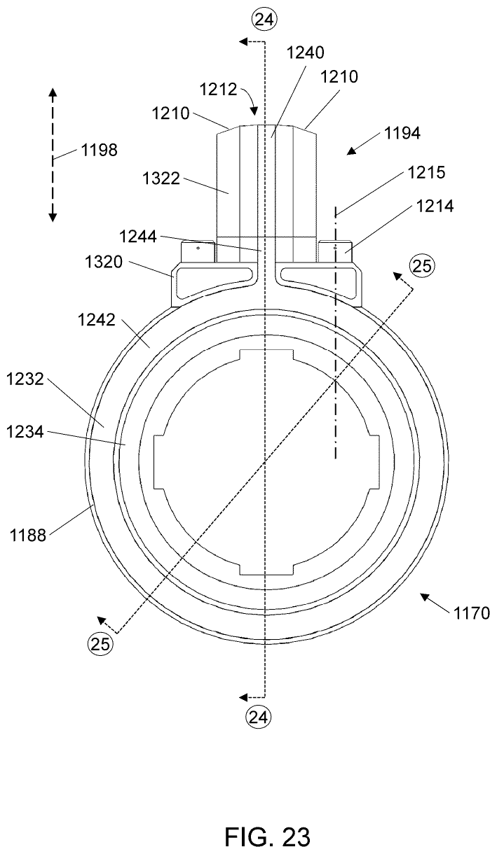

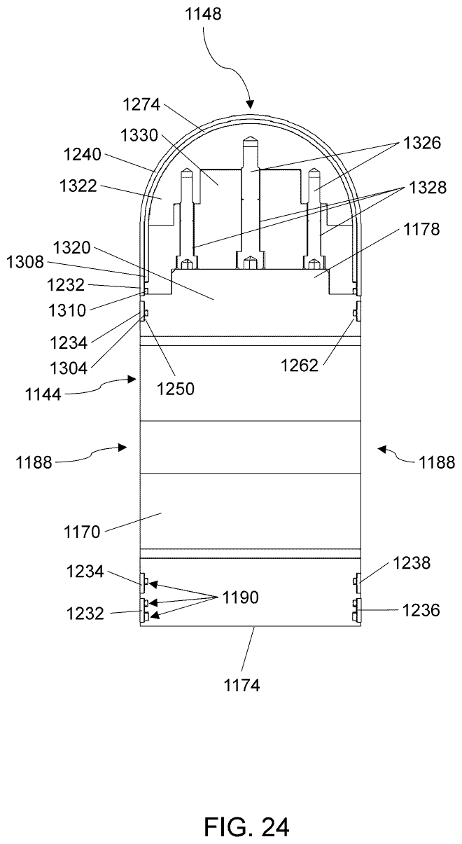

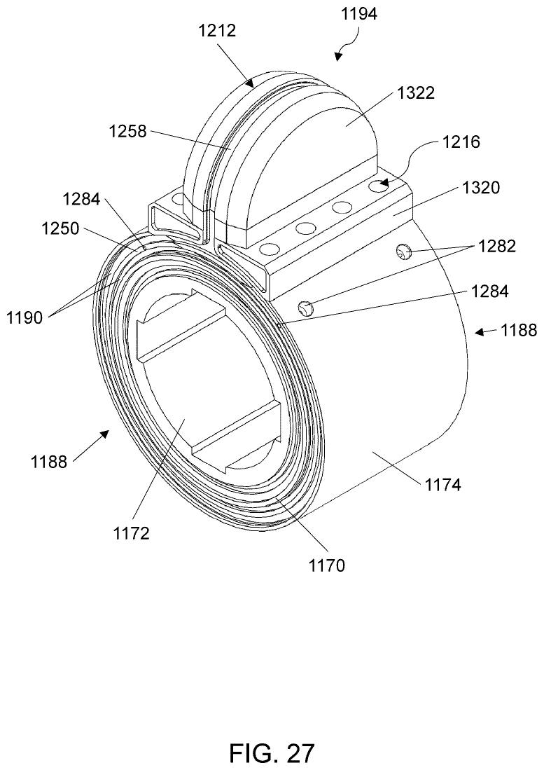

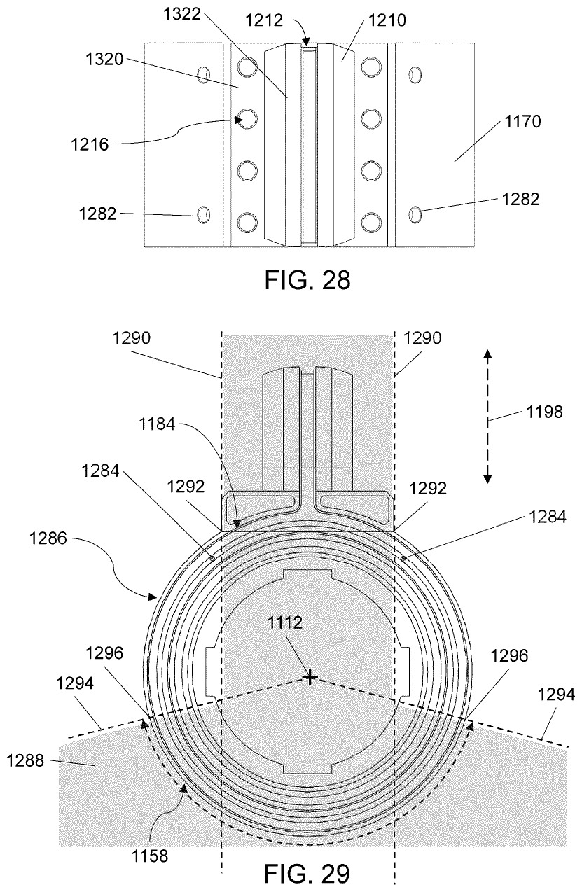

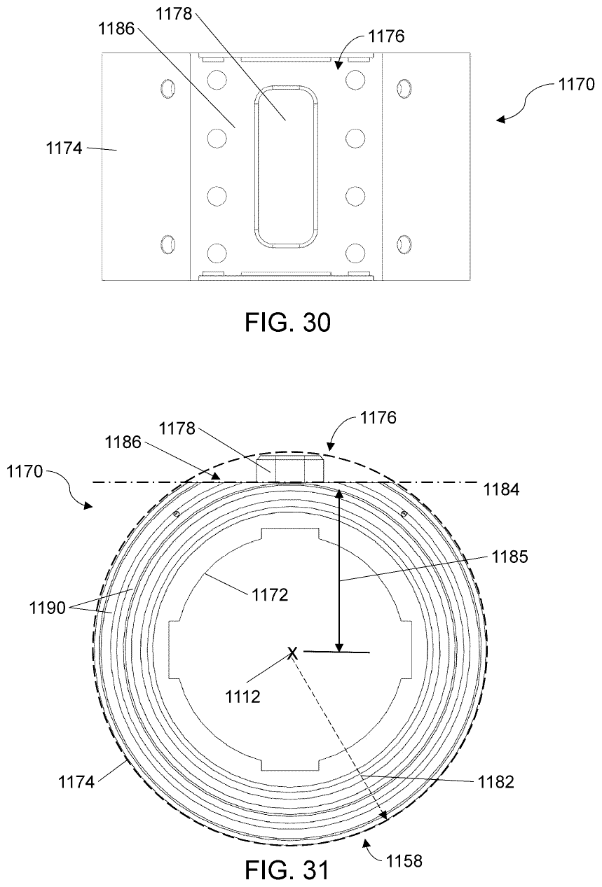

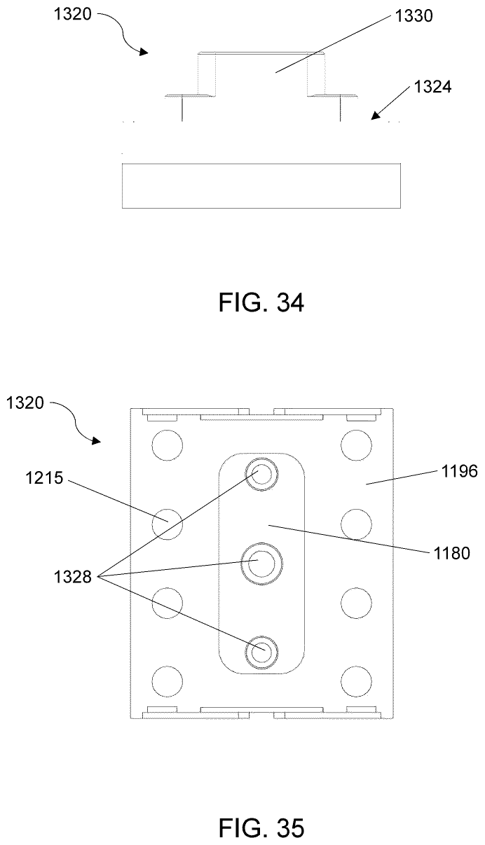

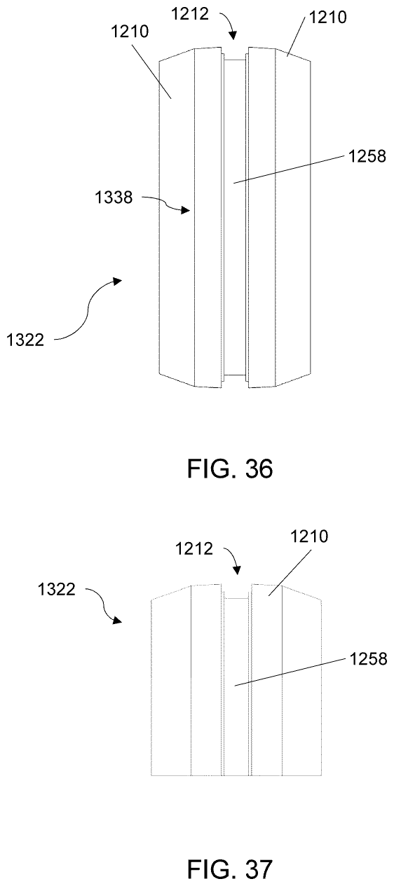

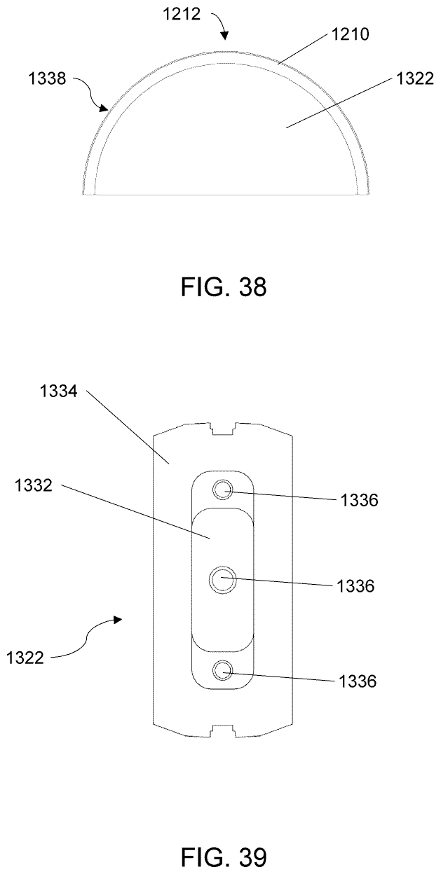

An outer contour 144 of the vane assembly 106 (see e.g. FIGS. 5 and 11) generally corresponds to an inner contour 146 of the casing 102 in the vane-swept region 142. The outer contour 144 is defined by two opposing axial ends of the vane assembly 106 and a vane of the vane assembly 106 (described below). Preferably, a distal portion 148 of the outer contour 144 of the vane assembly 106 has a complimentary shape to the inner contour 146 of the casing 102 in a radially-outer portion 150 of the vane-swept region 142. The distal portion 148 of the outer contour 144 is the portion of the outer contour 144 that extends radially outward beyond a generally cylindrical central body of the vane assembly 106. As shown in e.g. FIGS. 5 and 11, the distal portion 148 of the outer contour 144 may be substantially rectangular. This rectangular shape generally corresponds to the shape of the inner contour 146 provided by the casing body 124 and the end assemblies 126 in the radially-outer portion 150 the vane-swept region 142. In other embodiments, the distal portion 148 of the outer contour 144 may be rounded and/or may generally correspond to a semi-toroidal inner contour of the casing 102 in the radially-outer portion 150 of the vane-swept region 142 (such as in the embodiment shown in FIGS. 21 to 39).

The dam 108 is configured to cooperate with the vane assembly 106 to split the internal cavity 114 of the casing 102 into the first pressure chamber 116 and the second pressure chamber 118. The dam 108 is secured to the casing 102 within the internal cavity 114 and engages the vane assembly 106. In particular, the dam 108 sealingly engages a dam sealing portion 158 of the vane assembly 106. As the vane assembly 106 rotates, the dam 108 sweeps across the dam sealing portion 158 of the vane assembly 106 and defines a dam-sweep angle 160. As will be appreciated, in the subject embodiment, the dam-sweep angle 160 is equal and opposite to the vane-sweep angle 140. In embodiments where the vane-sweep angle 140 is less than 180 degrees, a transition angle 162 is defined between the vane-sweep angle 140 and the dam-sweep angle 160. In the subject embodiment, the vane-sweep angle is in the range of 75 to 135 degrees, and the dam-sweep angle is in the range of 75 to 135 degrees. In a preferred embodiment, the vane-sweep angle is about 130 degrees and the dam-sweep angle is about 130 degrees. In some embodiments, the vane-sweep angle 140 can be defined from a reference position. For example, the vane-sweep angle 140 can be +/−65 degrees from the reference position, which would be equivalent to a vane-sweep angle of 130 degrees as described above. In the embodiment shown in FIG. 7, the reference position is where a vane of the vane assembly 106 is directly opposite the dam 108 (i.e., a vertical position as shown in FIG. 7). In other embodiments, the reference position may be offset from being directly opposite the dam, such as by an offset angle.

In the embodiment shown in FIG. 7, two fluid control passages 120 are provided through the dam 108. The fluid control passages 120 extend between the first pressure chamber 116 and the second pressure chamber 118, to allow fluid flow therebetween. The fluid control passages 120 are similar but oriented in opposite directions. Each of the fluid control passages 120 includes a flow control device 166 to control fluid flow in the respective passage. The flow control device 166 restricts flow in the respective passage until a predetermined criteria is met, such as when a predetermined pressure is reached in an upstream one of the pressure chambers 116, 118. The flow control device 166 can be a valve, such as pressure relief valve, or another suitable flow control mechanism. In some embodiments, the flow control device 166 can be an adjustable flow control device. The adjustable flow control device can be adjustable from outside of the casing 102, such as by a screw or other adjustment mechanism that is accessible at an outside of the casing 102. As shown in FIG. 5, the adjustable flow control device can comprise one or more valve cartridges 168. The valve cartridges 168 can be accessed from an outside of the casing 102 by removing protective plugs 169 and inserting a tool (such as a screwdriver) to adjust the valve cartridges 168.

The fluid control passages 120 and the flow control devices 166 help to regulate flow between the first pressure chamber 116 and the second pressure chamber 118 during operation of the snubber 100. By regulating flow between the first and second pressure chambers 116, 118, the dampening provided by the snubber 100 can be controlled to help achieve a desired dampening. While two fluid control passages 120, each with a single flow control device 166, are shown in the subject embodiment, it will be appreciated that in other embodiments the snubber 100 may comprise only a single fluid control passage 120, or may comprise more than two fluid control passages 120. In some embodiments, fluid control passage(s) may be provided in the casing 102 of the snubber 100, such as in the casing body 124 and/or in the end assemblies 126, instead of or in addition to being provided in the dam 108. In some embodiments, a plurality of flow control devices 166 may be included in each fluid control passage 120, or no flow control devices may be included and the fluid control passages 120 itself may be sized to help achieve the desired dampening. In some embodiments, the snubber 100 may comprise an accumulator (not shown) in fluid communication with at least one of the fluid control passages 120 and/or in fluid communication with at least one of the pressure chambers 116, 118. The accumulator can help to compensate for thermal expansion of the fluid in the snubber 100. The accumulator can be housed within the casing 102.

The displacement bodies 110 are configured to occupy space in the first and second pressure chambers 116, 118 to reduce an amount of fluid required to fill the chambers 116, 118. In the subject application, the snubber 100 comprises a pair of displacement bodies 110. The displacement bodies 110 are secured to the casing 102, with one of the displacement bodies 110 in each of the pressure chambers 116, 118. To avoid interference with the vane assembly 106 as the vane assembly 106 rotates within the internal cavity 114, the displacement bodies 110 are positioned outside of the vane-swept region 142 in the internal cavity 114. As shown in FIG. 7, each of the displacement bodies 110 is generally kidney shaped. To help with interchangeability and parts replacement, the displacement bodies 110 may all have the same shape or substantially the same shape. In the subject embodiment, each of the displacement bodies 110 extends circumferentially about the snubber axis 112 from a respective side of the dam 108 to the nearest limit of the vane-swept region 142. In this way, the displacement bodies 110 and the dam 108 cooperate to reduce the amount of fluid required to fill the first and second pressure chambers 116, 118. The displacement bodies 110 occupy a predetermined volume of the first and second pressure chambers 116, 118 outside of the vane-swept region 142, and preferably occupy up to 100% of that volume.

During operation, the shaft 104 of the snubber 100 is coupled to a rotatable part to provide dampening, such as to dampen rotation of a door on a bucket of an excavator. As the shaft 104 rotates with the part, the vane assembly 106 that is coupled to the shaft 104 rotates within the internal cavity 114. This rotation of the vane assembly 106 increases the pressure in one of the pressure chamber (e.g., the first pressure chamber 116) and decreases pressure in the other of the pressure chambers (e.g., the second pressure chamber 118). The difference in pressure between the chambers causes fluid to flow from the first pressure chamber 116 to the second pressure chamber 118 (or vice versa) through the fluid control passages 120. By controlling the rate of fluid flow in the fluid control passages 120, a desired dampening can be provided by the snubber 100. The rate of fluid flow in the fluid control passages 120 can be controlled using the flow control devices 166, or by the geometry of the fluid control passages 120, or both. As will be appreciated, any fluid that passes between the first and second pressure chambers 116, 118 without flowing through the fluid control passages 120, such as by flowing around the outer profile of the vane assembly, may reduce the dampening provided by the snubber 100 and/or may undermine control of the dampening. As such, it is generally desirable to reduce the amount of fluid that bypasses the fluid control passages 120. Thus, it is generally desirable to provide a vane assembly 106 that has an outer contour 144 that generally corresponds to the inner contour 146 of the casing 102 in the vane-swept region 142. It is also generally desirable to provide one or more seal assemblies between the vane assembly 106 and the casing 102, such as the seal assemblies described below.

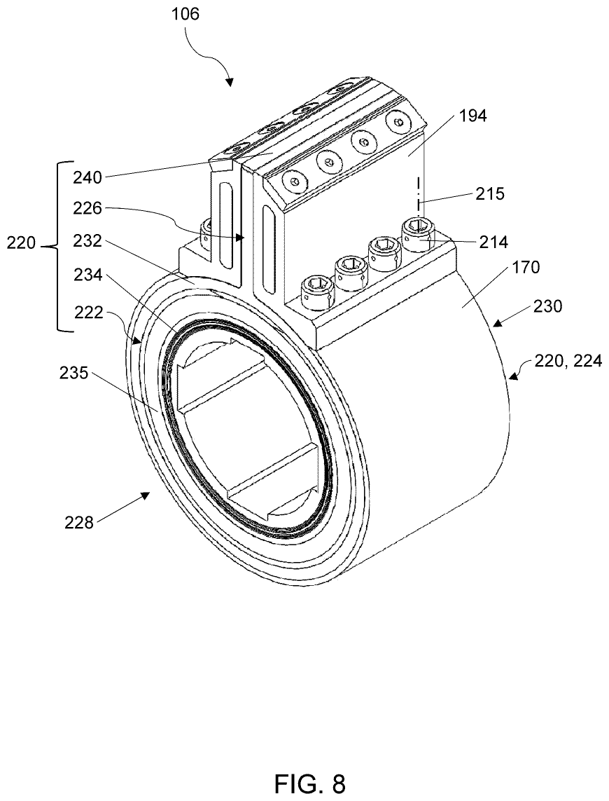

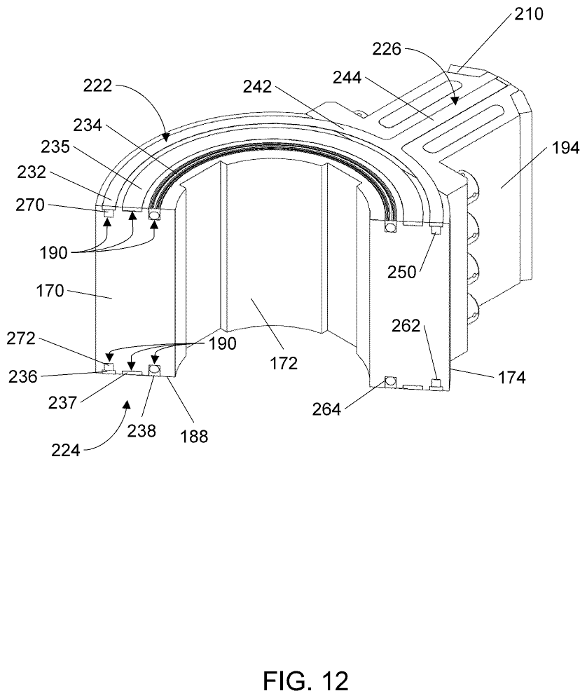

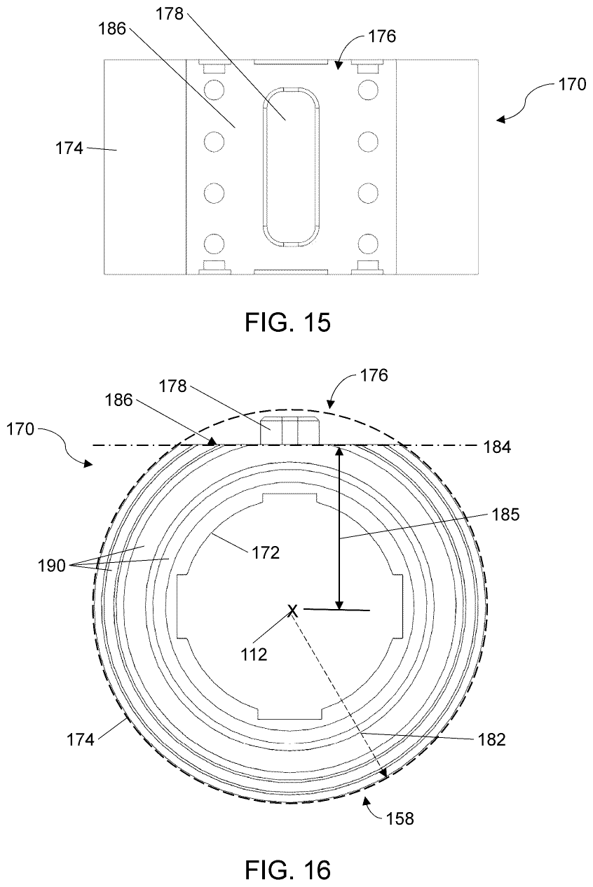

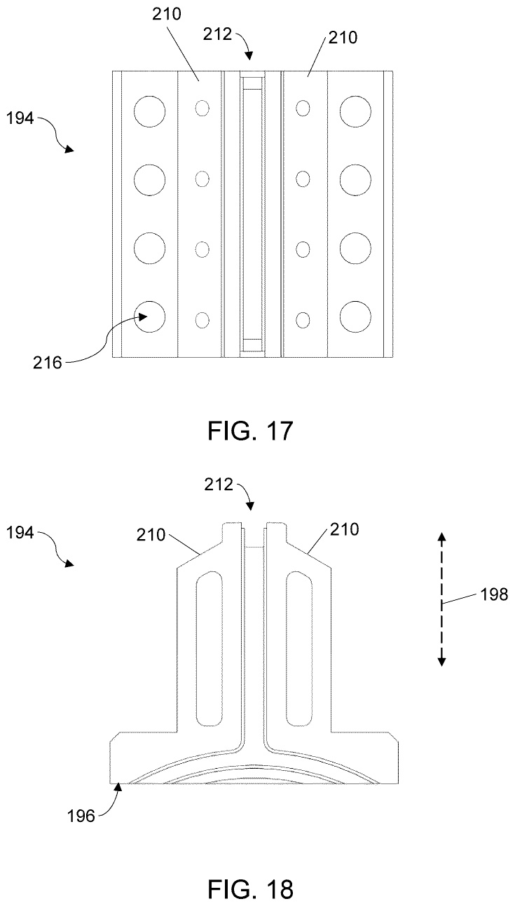

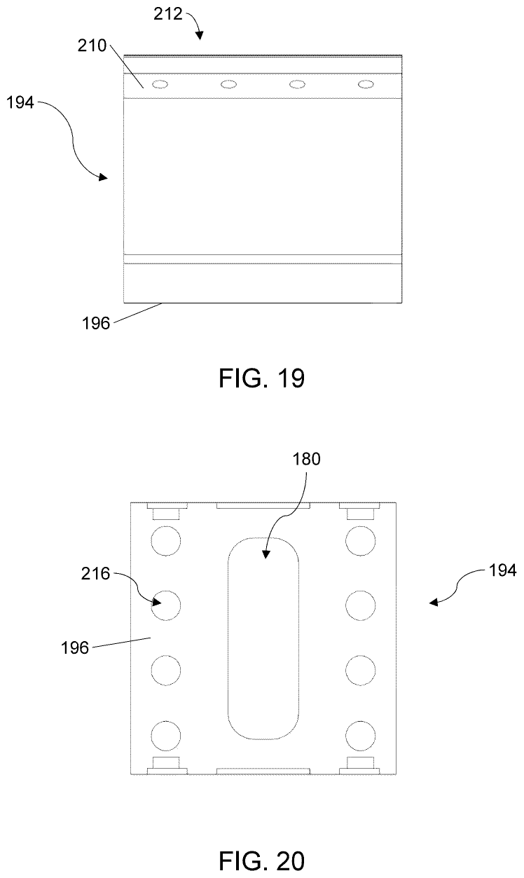

FIGS. 8 to 20 show the vane assembly 106 of the snubber 100. The vane assembly 106 comprises a hub 170, a vane 194, and a seal assembly 220. The hub 170 is configured to be mounted on the shaft 104 of the snubber 100, such that the hub 170 rotates with the shaft 104 about the snubber axis 112. The vane 194 is, in this example, removably secured to the hub 170 to rotate with the hub 170. The seal assembly 220 extends across at least a portion of the outer contour 144 of the vane assembly 106 to provide a seal between the casing 102 of the snubber 100 and the vane assembly 106.

The hub 170 is configured to secure the vane assembly 106 to the shaft 104 of the snubber 100. As shown in FIG. 16, the hub 170 comprises an inner surface 172 for mounting on the shaft 104 of the snubber 100. The inner surface 172 includes a plurality of keyways that mesh with keys on the shaft 104. The hub 170 further comprises an outer surface 174 that includes at least a vane mounting portion 176 and the dam sealing portion 158. The dam 108 of the snubber 100 engages the dam sealing portion 158 of the hub 170. The vane 194 is configured to be removably secured to the vane mounting portion 176 of the hub 170. The vane mounting portion 176 of the hub 170 optionally comprises a vane reinforcing feature, which is configured to reinforce the vane 194 when the vane 194 is secured to the hub 170. In the subject embodiment, the vane reinforcing feature is a hub protrusion 178 that is configured to reinforce the vane 194 when the vane 194 is secured to the hub 170. The hub protrusion 178 extends radially outward in the vane mounting portion 176 of the hub 170 and is sized to fit within a pocket 180 in the vane 194 (see FIG. 20). Preferably, the hub protrusion 178 extends radially beyond a centroid of the vane when the vane 194 is secured to the hub 170. Having the vane reinforcing feature extend radially beyond the centroid of the vane can help the vane reinforcing feature resist forces on the vane 194 during operation, which may improve longevity and/or performance of the snubber 100. In some embodiments, the vane reinforcing feature comprises a vane key receiving pocket in the vane mounting portion 176 of the hub 170 and a vane reinforcing key. The vane reinforcing key is sized to fit within the vane key receiving pocket, i.e., mates with the vane key receiving pocket, and extends from the vane key receiving pocket into the pocket 180 in the vane 194. Similar to the hub protrusion 178, the vane reinforcing key can be sized to extend radially beyond the centroid of the vane, when the vane 194 is secured to the hub 170.

As shown in FIG. 16, the hub 170 defines a maximum radius 182. In this example, no part of the hub 170 extends radially outward of the maximum radius 182. In the subject embodiment, the maximum radius 182 is set by the dam sealing portion 158 of the hub 170. Accordingly, the vane mounting portion 176, including the hub protrusion 178, is entirely contained inside of the maximum radius 182 set by the dam sealing portion 158. Resultantly, at least the dam sealing portion 158 of the hub 170 can be manufactured using an uninterrupted turning operation, such as on a lathe. Thereafter, the vane mounting portion 176 can be manufactured by an uninterrupted milling operation, to complete the outer surface 174 of the hub 170. This limited sequence of operations for constructing the outer surface 174 of the hub 170 may reduce cost and help to simplify manufacturing of the hub 170. Preferably, the vane mounting portion 176 is entirely located between the maximum radius 182 of the hub 170 and a vane mounting plane 184 that is defined by an innermost surface 186 of the vane mounting portion 176. In some embodiments, the vane mounting plane 184 can be spaced apart from the snubber axis 112 by an offset distance 185 in the vane-vertical direction 198 (described below) by between 65% and 95% of the maximum radius, inclusive. In the subject embodiment, the offset distance 185 separating the vane mounting plane 184 is spaced apart from the snubber axis 112 in the vane-vertical direction is about 85% of the maximum radius 182.

The hub 170 comprises a pair of axially opposed end surfaces 188. Each of the end surfaces 188 comprises a plurality of channels 190 for receiving seals (as described below). Each of the channels 190 is circular. Accordingly, at least one of the end surfaces 188 and the dam sealing portion 158 of the hub 170 can be completely machined, including the channels 190 in the one of the end surfaces 188, in the same uninterrupted turning operation (i.e., without removing the hub from a lathe performing the turning operation). This can help simplify manufacturing of the hub and may reduce costs. Put another way, the dam sealing portion 158 and at least one of the end surfaces 188, including any channels therein, are, in this example, entirely defined by a plurality of circular arcs that are all coaxial and are each defined at a respective axial position and radial depth or a respective radial position and axial depth, such that the arcs can all be completed by a lathe in a continuous operation, or the like.

Optionally, the hub 170 may include a pressure conduit that allows fluid to flow from the first pressure chamber 116 and/or the second pressure chamber 118 into one or more of the channels 190 of the hub 170. While this pressure conduit is not shown in the embodiment of FIGS. 8 to 20, it will be appreciated that this pressure conduit can be similar to the one shown and described below with respect to the embodiment of FIGS. 21 to 39.

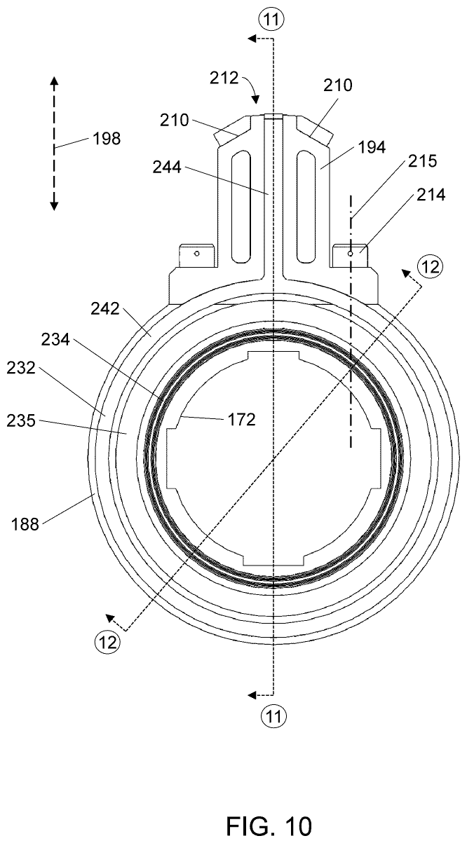

The vane 194 is configured to be removably secured to the hub 170 to rotate with the hub 170 about the snubber axis 112. Accordingly, the vane 194 comprises a hub facing surface 196 for mounting to the vane mounting portion 176 of the hub 170 (see FIG. 18). As the vane 194 rotates during operation of the snubber 100, the vane 194 forces fluid within the snubber 100 from the first pressure chamber 116 to the second pressure chamber 118, or vice versa. The vane 194 extends from the hub 170 in a vane-vertical direction 198. The vane-vertical direction 198 is a direction that would be parallel to a radial direction of the vane assembly 106 at a circumferential midpoint of the vane 194. Accordingly, in the subject embodiment, the vane-vertical direction 198 is an upward/downward direction as shown in at least FIGS. 10 and 18. The vane 194 defines a vane portion 200 of the outer contour 144 of the vane assembly 106. As shown in FIG. 11, the vane portion 200 of the outer contour 144 extends from a first axial edge 202 of the vane 194 to an opposite, second axial edge 204 of the vane 194. Accordingly, in the subject embodiment, the vane portion 200 includes the distal portion 148 of the outer contour 144. That is, the distal portion 148 of the outer contour 144 is defined within, or as a part of, the vane portion 200 of the outer contour 144. The vane portion 200 comprises two opposing, straight vane-vertical portions 206 and a flat tip portion 208. The flat tip portion connects the two opposing, straight vane-vertical portions 206 of the outer contour 144. Accordingly, in the subject embodiment, the vane portion 200 of the outer contour 144 is substantially square (or substantially rectangular). In other embodiments, the vane portion of the outer contour 144 may have a different shape, such as a rounded shape as shown in the embodiment of FIGS. 21 to 39. The vane 194 comprises at least one chamfer surface 210 adjacent a distal tip 212 of the vane 194, as shown in FIG. 18. During operation, pressure acts radially inward on the vane 194.

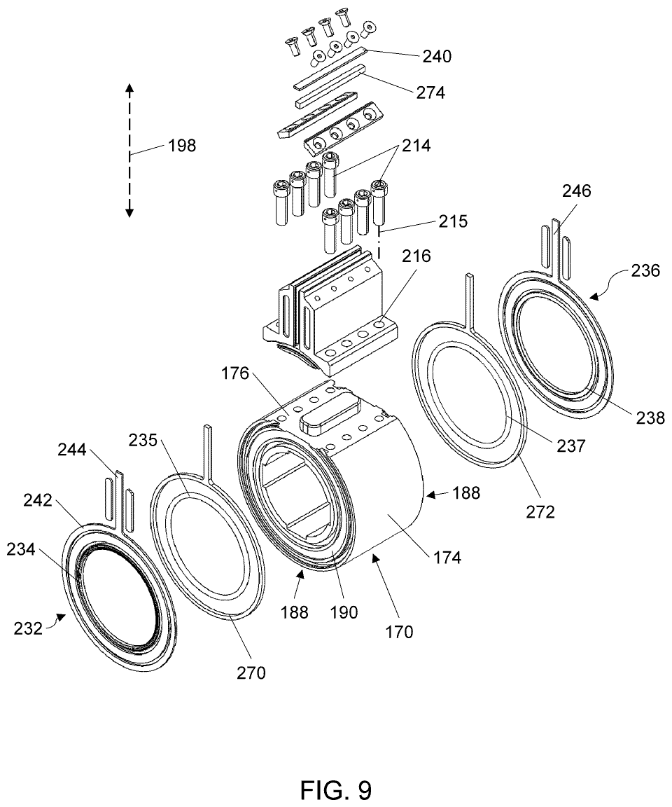

The vane 194 is secured to the hub 170 by a plurality of vane fasteners 214, each extending along a respective fastener axis 215 (see FIGS. 8 to 10). Each of the vane fasteners 214 is oriented generally parallel to the vane-vertical direction 198. The vane fasteners 214 extend through bores 216 in the vane 194 and into the vane mounting portion 176 of the hub 170. As shown in FIGS. 9 and 20, the bores 216 extend through the vane 194 in the vane-vertical direction 198, and through the hub facing surface 196 of the vane 194. Accordingly, none of the bores 216 extend through the vane 194 in a generally circumferential direction of the vane 194. Having none of the bores 216 extend circumferentially through the vane 194 can help reduce the likelihood of fluid leaking through the vane 194 from the first pressure chamber 116 to the second pressure chamber, or vise versa, during operation of the snubber 100. Thus, fluid bypassing the fluid control passages 120 may be reduced by orienting the vane fasteners 214 and the bores 216 parallel to the vane-vertical direction 198. In other embodiments, the vane 194 can be secured to the hub 170 by a dovetail joint between the hub facing surface 196 and the vane mounting portion 176. The dovetail joint may be in addition to, or instead of, the vane fasteners 214. Preferably, the dovetail joint is oriented generally parallel to the snubber axis 112. In some embodiments, the dovetail joint may provide the vane reinforcing feature described above. The vane 194 may comprise at least one of a mechanical seal and a sealing adhesive between the hub facing surface 196 of the vane 194 and the vane mounting portion 176 of the hub 170. In some embodiments, a sealing adhesive may be applied across substantially all of the hub facing surface 196 and/or the vane mounting portion 176. Providing a seal at the interface of the vane 194 and the hub 170 may help inhibit or prevent a separation force (i.e. fluid pressure tending to separate vane 194 and hub 170) resulting from fluid leaking between vane 194 and hub 170. Providing a seal at the interface of the vane 194 and the hub 170 may also help restrict fluid leaking between the first and second pressure chambers 116, 118 along this interface.

The seal assembly 220 is configured to provide a seal between the casing 102 and the vane assembly 106 of the snubber 100. In the subject embodiment, the seal assembly 220 provides a seal between the inner contour 146 of the casing 102 and the outer contour 144 of the vane assembly 106 in the vane-swept region 142. The seal assembly 220 generally comprises a plurality of seal regions. In the subject embodiment, the plurality of seal regions include a first axial seal region 222, a second axial seal region 224, and a vane seal region 226. The first axial seal region 222 is located at a first axial end 228 of the vane assembly 106 and provides a seal between the first axial end 228 and the casing 102 of the snubber 100. As shown in FIG. 8, the first axial seal region 222 surrounds the snubber axis 112 at the first axial end 228 of the vane assembly 106. The second axial seal region 224 is located at a second axial end 230 of the vane assembly 106, opposite the first axial end 228, and provides a seal between the second axial end 230 and the casing 102 of the snubber 100. The second axial seal region 224 encircles the snubber axis 112 at the second axial end 230. The vane seal region 226 provides a seal between the casing 102 and at least part of the vane 194, such as the distal portion 148 of the outer contour 144. In the subject embodiment, the vane seal region 226 provides a seal between the casing 102 and a majority of the vane 194, and the first and second axial seal regions 222, 224 provide the remaining small part of the seal between the vane 194 and the casing 102 (near the first and second axial edges 202, 204 of the vane 194). The vane seal region 226 extends between and connects the first axial seal region 222 and the second axial seal region 224. The vane seal region 226 follows the vane portion 200 of the outer contour 144, including the distal portion 148 thereof, and extends substantially from the first axial edge 202 of the vane 194 to the second axial edge 204 of the vane 194.

As will be appreciated, each of the seal regions 222, 224, 226 may comprise one or more seals, such as the seals described below. The seals may be pressure-energized seals or “pressure-boosted” seals. As described herein, “pressure-boosted” seals are seals that utilize fluid pressure from fluid directed via a conduit from the pressure chambers 116, 118 to within the seal assembly to increase the force acting on the cap of the seal. In embodiments where a seal region only comprises pressure-energized seals, that region is described as “pressure-energized” or a “pressure-energized seal region”. In contrast, when a seal region only comprises pressure-boosted seals, that region is described as “pressure-boosted” or a “pressure-boosted seal region”. In embodiments where the seal region comprises both pressure-energized and pressure-boosted seals, that region is described as “mixed” or a “mixed seal region”. As described below, in the embodiment shown in FIGS. 8 to 20, the seal regions 222, 224, 226 are all pressure-energized seal regions. In the embodiment shown in FIGS. 21 to 39, the first and second axial seal regions 1222, 1224 are mixed seal regions and the vane seal region 1226 is pressure-energized.

The seal assembly 220 comprises a plurality of seals, which are each position in at least one of the seal region 222, 224, 226. In the embodiment of FIGS. 8 to 20, the seal assembly 220 comprises a first end primary cap seal 232, a first end secondary cap seal 234, a second end primary cap seal 236, a second end secondary cap seal 238, and a distal cap seal 240.

The first end primary cap seal 232 is provided at the first axial end 228 of the vane assembly 106 and has a first closed-loop portion 242 and a first tail portion 244 (see FIG. 9). The first closed-loop portion 242 circumferentially surrounds the snubber axis 112 at the first axial end 228 of the vane assembly 106. Accordingly, the first closed-loop portion 242 is positioned in the first axial seal region 222 of the seal assembly 220. In the subject embodiment, the first closed-loop portion 242 is shaped as a completely closed circle. The first tail portion 244 extends radially outward from the first closed-loop portion 242 and is positioned in the vane seal region 226. Accordingly, the first end primary cap seal 232 is positioned within both the first axial seal region 222 and the vane seal region 226 of the seal assembly 220. The first closed-loop portion 242 of the first end primary cap seal 232 provides sealing between at least the hub 170 and the casing 102 of the snubber 100. In the subject embodiment, the first closed-loop portion 242 further provides sealing between the vane 194 and the casing 102 of the snubber 100, near the first axial edge 202 of the vane 194. The first tail portion 244 provides sealing between the vane 194 and the casing 102 of the snubber 100. In the subject embodiment, the first tail portion 244 provides sealing along part of the distal portion 148 of the outer contour 144 of the vane assembly 106. As shown in at least FIG. 9, the first tail portion 244 and the first closed-loop portion 242 of the first end primary cap seal 232 are flat. Accordingly, the entire first end primary cap seal 232 is substantially flat, which can facilitate manufacturing of the first end primary cap seal 232 by allowing the first end primary cap seal 232 to be punched or cut from a flat sheet of stock material.

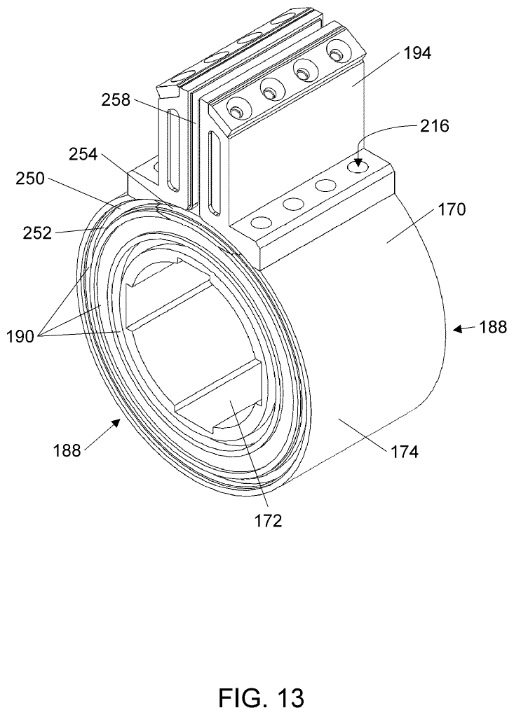

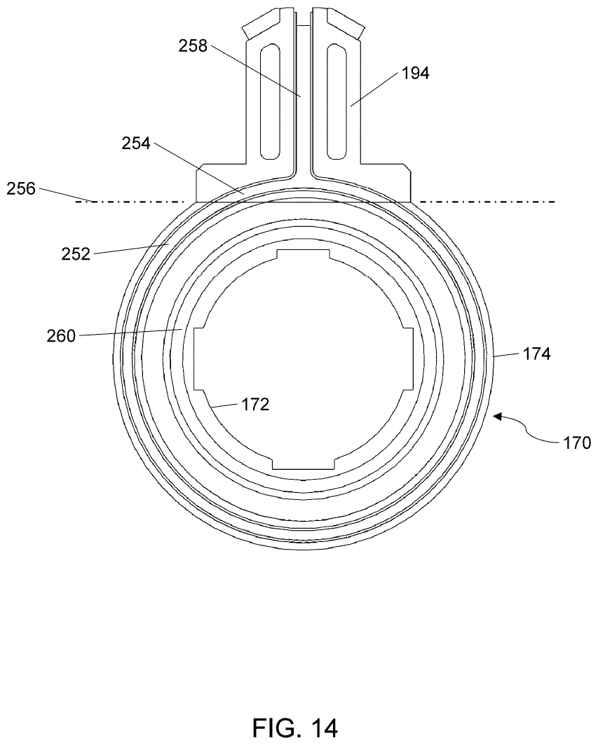

The first closed-loop portion 242 of the first end primary cap seal 232 is received within a first end closed-loop channel 250 of the vane assembly 106 (see FIG. 13). The first end closed-loop channel 250 is located at the first axial end 228 of the vane assembly 106 and comprises a hub portion 252 and a vane portion 254 (see FIG. 14). The hub portion 252 is defined in the hub 170 of the vane assembly 106, and the vane portion 200 is defined in the vane of the vane assembly 106. The hub portion 252 of the first end closed-loop channel 250 extends circumferentially around the snubber axis 112 and terminates at the vane mounting portion 176 of the hub 170. The vane portion 200 of the first end closed-loop channel 250 starts at the hub facing surface 196 of the vane 194 and extends adjacent the first axial edge 202 of the vane 194.

Accordingly, when the vane 194 is mounted on the hub 170, the vane portion 200 and the hub portion 252 cooperate to define the first end closed-loop channel 250. As will be appreciated, the vane mounting portion 176 defines a boundary 256 between the hub portion 252 and the vane portion 200 of the first end closed-loop channel 250. The first tail portion 244 is received within a vane channel 258, which is defined in the vane 194. The vane channel 258 follows the distal portion 148 of the outer contour 144 of the vane assembly 106. The vane channel 258 extends from the first end closed-loop channel 250 at the first axial end 228 of the vane assembly 106 to a second end closed-loop channel at the second axial end 230 of the vane assembly 106.

The first end secondary cap seal 234 is provided at the first axial end 228 of the vane assembly 106 and is configured to provide additional sealing between the hub 170 and the casing 102 of the snubber 100. Providing additional sealing can be desirable, in case the sealing provided by the first end primary cap seal 232 is insufficient or fails. Accordingly, the first end secondary cap seal 234 is located radially inward of the first end primary cap seal 232 at the first axial end 228 of the vane assembly 106, such that the first end primary cap seal 232 circumferentially surrounds the first end secondary cap seal 234. The first end secondary cap seal 234 circumferentially surrounds the snubber axis 112 at the first axial end 228 of the vane assembly 106. The first end secondary cap seal 234 is received within a first end secondary seal channel 260 of the vane assembly 106. The first end secondary seal channel 260 is defined in the hub 170 of the vane assembly 106 at the first axial end 228 thereof and is positioned radially inward of the first end closed-loop channel 250 in the hub 170.

The second end primary cap seal 236 and the second end secondary cap seal 238 are identical to the first end primary cap seal 232 and the first end secondary cap seal 234, respectively, but are provided at the second axial end 230 of the vane assembly 106, and are received in a second end closed-loop channel 262, a second end secondary seal channel 264, and the vane channel 258, at the second axial end 230 of the vane assembly 106. Accordingly, the above descriptions of the first end primary cap seal 232, first end secondary cap seal 234, and their related channels apply mutatis mutandis to the second end primary cap seal 236, the second end secondary cap seal 238, and their related channels.

In the illustrated example, hub 170 also includes a wear strip 235 (which may also be characterized as a bearing strip) nested circumferentially between first end primary cap seal 232 and first end secondary cap seal 234, and a wear (or bearing) strip 237 nested circumferentially between second end primary cap seal 236 and second end secondary cap seal 238. Wear strips 235, 237 may reduce friction between hub 170 and casing 102 during rotation of shaft 104.

The distal cap seal 240 is provided at the distal tip 212 of the vane 194. The distal cap seal 240 is configured for sealing between the distal tip 212 of the vane 194 and a radially outermost portion of the inner contour 146 of the casing 102. The distal cap seal 240 extends between and connects the first tail portion 244 of the first end primary cap seal 232 to a second tail portion 246 of the second end primary cap seal 236. As shown in FIG. 9, the distal cap seal 240 is generally straight. Accordingly, the tail portions 244, 246 of the primary cap seals 232, 236 and the distal cap seal 240 cooperate to provide sealing between the substantially square (or substantially rectangular) distal portion 148 of the outer contour 144 and the inner contour 146 of the casing 102. In some embodiments, the distal cap seal 240 can be coupled to the tail portion 244, 246 of the primary cap seals 232, 236 by lap joints and/or bridal joints. The distal cap seal 240 is received within the vane channel 258, at the distal tip 212 of the vane 194. In the subject embodiment, the vane 194 comprises only a single vane channel 258. Providing a single vane channel 258 may help to facilitate manufacturing of the vane 194. Moreover, the vane channel 258 is entirely formed in the vane 194 and does not extend into the hub 170 of the vane assembly 106, which may further facilitate manufacturing.

Preferably, the seal assembly 220 further comprises a first end primary seal energizer 270, a second end primary seal energizer 272, and a distal seal energizer 274 (see FIG. 9). Each of the seal energizers underlies a respective one of the cap seals and has a substantially similar shape to the overlying cap seal. The seal energizers are formed of resilient elastic material, such as a resilient elastic rubber-like material, and press the overlying cap seals against the casing during operation of the snubber to improve the seal between the vane assembly and the casing. In contrast, the cap seals are formed of a rigid, wear resistant material, preferably a low-friction wear resistant material such as bronze-filled polytetrafluoroethylene (PTFE). In some embodiments, the seal assembly 220 may further comprise a first end secondary seal energizer and a second end secondary seal energizer (such as those described below in the embodiment of FIGS. 21 to 39).

As will be appreciated, the seals described above can all be characterized as pressure-energized seals, as none of the cap seals 232, 234, 236, 238, 240 and none of the seal energizers 270, 272, 274 are pressure-boosted. That is, none of the above seals utilize fluid pressure from pressure chambers 116, 118 directed below the cap seals to increase the sealing force of the seal. Accordingly, in the embodiment of FIGS. 8 to 20, the first axial seal region 222, the second axial seal region 224, and the vane seal region 226 are all pressure-energized seal regions.

Turning to FIGS. 21 to 39, another embodiment of a vane assembly is shown and generally identified by reference character 1106. The vane assembly 1106 is generally similar to the vane assembly 106, and like elements are identified with like reference numbers incremented by 1000. However, the vane assembly 1106 has a seal assembly 1220 which includes a pressure-boosted seal, a hub 1170 which includes a pressure conduit, and a vane 1194 which includes a rounded nose and a pedestal. Accordingly, the vane assembly 1106 is configured to be used with a snubber that is substantially similar to the snubber 100, but has a differently shaped inner contour in the vane-swept region of the casing. Specifically, a snubber with a differently shaped radially outermost portion of the inner contour in the vane-swept region. This differently shaped contour is rounded at the radially outermost portion, such that the radially outermost portion follows the shape of an outer circumferential surface of a torus (i.e., a partial toroidal shape).

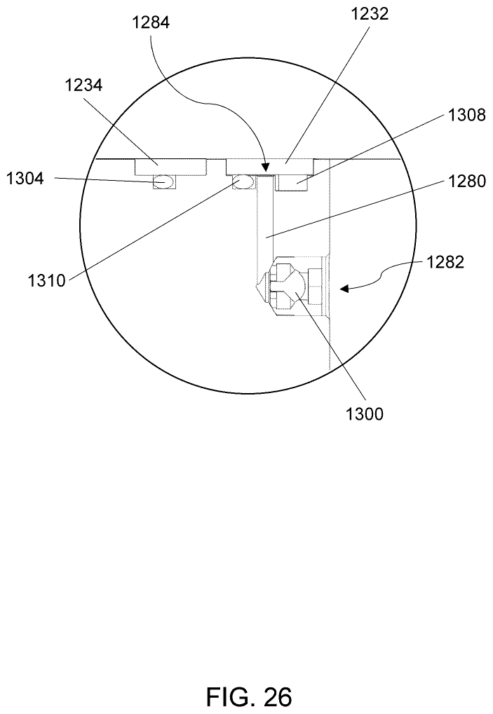

The hub 1170 is generally similar to the hub 170 but includes at least one pressure conduit 1280. The pressure conduit 1280 is configured to provide fluid pressure to a pressure-boosted seal (described below). The pressure conduit 1280 extends from a pressure inlet 1282 to a pressure outlet 1284 (see FIG. 26). The pressure inlet 1282 is positioned in the outer surface 1174 of the hub 1170. The pressure outlet 1284 is positioned in one of the first and second end closed-loop channels 1250, 1262. Accordingly, the pressure conduit 1280 allows pressurized fluid to flow from the first or second pressure chamber 1116, 1118 to one of the first and second end closed-loop channels 1250, 1262. In other embodiments, the pressure conduit may extend from a single pressure inlet in the outer surface 1174 of the hub 1170 to two pressure outlets, one in each of the first and second end closed-loop channels 1250, 1262. This may reduce the number of flow control devices, described below, in the vane assembly 1106. In embodiments where the pressure conduit extends to two pressure outlets, the pressure conduit may include a T-junction, or other split, between the pressure inlet and the pressure outlets.

In the subject embodiment, the pressure inlet 1282 is positioned outside of the vane mounting portion 1176 of the hub 1170 and is further positioned outside of the dam sealing portion 1158 of the hub 1170. That is, the pressure inlet 1282 is positioned in a transition portion 1286 of the outer surface 1174 of the hub 1170, between the vane mounting portion 1176 and the dam sealing portion 1158. In the subject embodiment, the pressure outlet 1284 is located outside of an exclusion region 1288. As shown in FIG. 29, The exclusion region 1288 extends between a pair of vertical planes 1290, each of which pass through a respective circumferential terminal edge 1292 of the vane mounting portion 1176 and extend in the vane-vertical direction 1198 and in the direction of the snubber axis 2112. The exclusion region 1288 further extends about the dam-sweep angle 1160 between a pair of planar bounds 1294 that each begin at the snubber axis 1112 and extend radially outward through a respective circumferential terminal edge 1296 of the dam sealing portion 1158 of the hub 1170.

A conduit flow control device 1300 is positioned in the pressure conduit 1280. The conduit flow control device 1300 is configured to restrict reverse flow in the pressure conduit 1280 (i.e., flow from the pressure outlet 1284 to the pressure inlet 1282). In the subject embodiment, the conduit flow control device 1300 is a check valve.

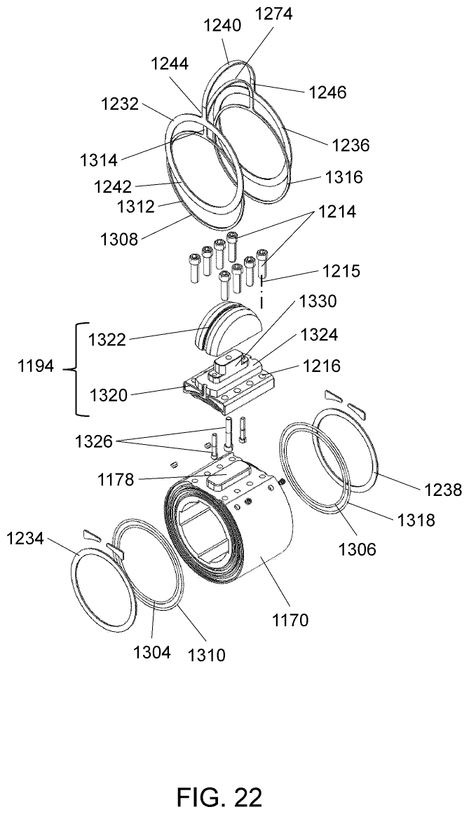

The seal assembly 1220 is configured to provide a seal between the casing of the snubber and the vane assembly 1106, similar to the seal assembly 220. The seal assembly 1220 comprises a first axial seal region 1222, a second axial seal region 1224, and a vane seal region 1226, which are generally similar to the seal region 222, 224, 226, respectively. However, as described below, the first and second axial seal regions 1222, 1224 are mixed seal regions and comprise a pressure-boosted seal. The seal assembly 1220 comprises a first end primary cap seal 1232, a first end secondary cap seal 1234, a second end primary cap seal 1236, and a second end secondary cap seal 1236, which are generally similar to the cap seals 232, 234, 236, 238, respectively. However, as will be seen in FIG. 22, the tail portions 1244, 1246 of the first and second end primary cap seals 1232, 1236 are slightly shorter than those of the first and second end primary cap seals 232, 236. Similar to first and second end primary cap seals 232, 236, the entire first and second end primary cap seals 1232, 1236 are substantially flat, which can facilitate manufacturing by allowing the seals 1232, 1236 to be punched or cut from a flat sheet of stock material. The seal assembly 1220 also comprises a distal cap seal 1240. The distal cap seal 1240 is generally similar to the distal cap seal 240; however, in contrast to the distal cap seal 240, the distal cap seal 1240 is curved. Accordingly, the tail portions 1244, 1246 of the primary cap seals 1232, 1236 and the distal cap seal 1240 cooperate to provide a semi-circular (or rounded) distal portion 1148 of the outer contour 1144.

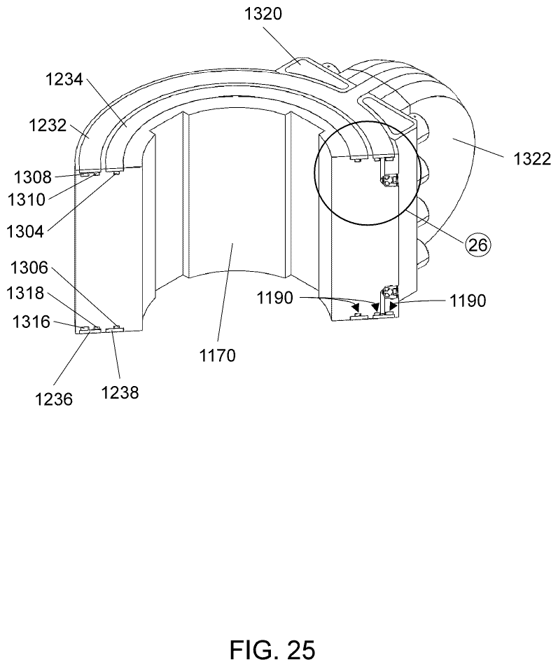

The seal assembly 1220 comprises a plurality of energizing seals. In the subject embodiment, the energizing seals include first and second end secondary energizing seals 1304, 1306 and a distal energizing seal 1274, each of which underly a respective one of the secondary cap seals 1234, 1238 and the distal cap seal 1240 and have substantially the same shape as the respective overlying seals. The seal assembly 1220 further comprises energizing seals underlying each of the first and second end primary cap seals 1232, 1236. As shown in FIG. 26, the seal assembly 1220 comprises a first end outer energizing seal 1308 and a first end inner energizing seal 1310, both of which underly the first end primary cap seal 1232. The first end inner energizing seal 1310 is circular in shape and is located radially inward of the first end outer energizing seal 1308. The first end outer energizing seal 1308 has generally the same shape as the first end primary cap seal 1232. More particularly, the first end outer energizing seal 1308 comprises a first energizing closed-loop portion 1312 and a first energizing tail portion 1314 (see FIG. 22), which underly, respectively, the first closed-looped portion 1242 and the first tail portion 1244 of the first end primary cap seal 1232. The seal assembly 1220 further comprises a second end outer energizing seal 1316 and a second end inner energizing seal 1318, which are generally similar to the first end outer and inner energizing seals described above and underly the second end primary cap seal 1236 (as shown in FIG. 25).

As shown in FIG. 26, the pressure outlet 1284 of the pressure conduit 1280 is positioned between the first end inner energizing seal 1310 and the first end outer energizing seal 1308, and is positioned underly the first end primary cap seal 1232—all within the first end closed-loop channel 1250. Accordingly, the pressure conduit 1280 provides fluid pressure from the first or second pressure chambers 1116, 1118 to an enclosed portion between the seals 1232, 1308, 1310 in the closed-loop channel and the hub 1170. This pressurizes the enclosed portion, which presses the first end primary cap seal 1232 outward to increase the sealing force against the inner contour of the casing of the snubber. In this way, the first end primary cap seal 1232, the first end outer energizing seal 1308, and the first end inner energizing seal 1310 form a 3-part seal that can be characterized as a pressure-boosted seal. Thus, the first axial seal region 1222 of the seal assembly 1220 is a mixed seal region, since it includes the first end secondary cap seal 1234 that is pressure-energized and the first end primary cap seal 1232 that is pressure-boosted. The arrangement of cap seals, energizing seals, and the pressure conduit in the second axial seal region 1224 is the same as the first axial seal region 1222 and is not repeated herein for brevity.

The vane 1194 comprises a pedestal 1320 and a nose 1322. The pedestal 1320 is removably secured to the hub 1170. The nose 1322 is removably secured to the pedestal 1320, opposite the hub 1170. Accordingly, the nose 1322 includes at least part of the distal portion 1148 of the outer contour 1144 of the vane assembly 1106 and includes the distal tip 1212 of the vane 1194. The pedestal 1320 includes the hub facing surface 1196 of the vane 1194. The pedestal 1320 and the nose 1322 can be formed from dissimilar materials. In some embodiments, the nose 1322 may be formed from a softer material than the material that pedestal 1320 is formed from.

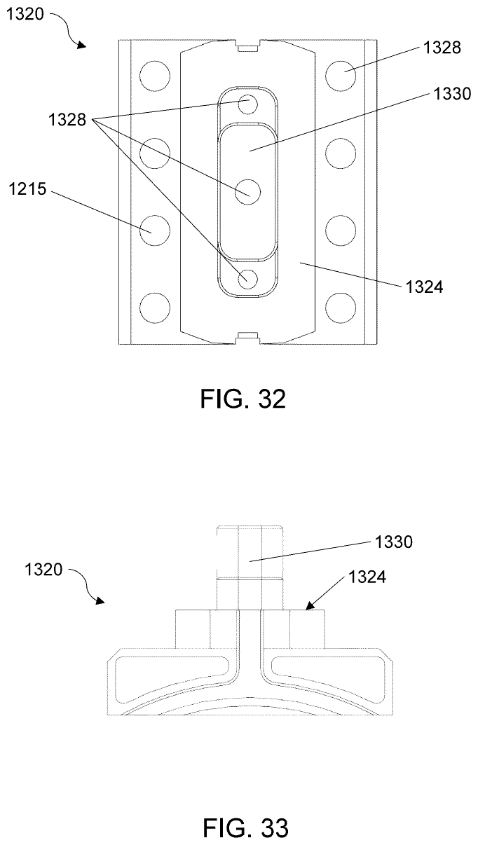

The pedestal 1320 is configured to mount the nose 1322 to the hub 1170. The pedestal 1320 comprises the hub facing surface 1196, which is secured to the vane mounting portion 1176 of the hub 1170. The pedestal 1320 is secured to the hub 1170 by a plurality of vane fasteners 1214. The pedestal 1320 further comprises a nose facing surface 1324 radially opposite the hub facing surface 1196. The nose 1322 is secured to the nose-facing surface 1324 of the pedestal 1320 by a plurality of nose fasteners 1326. The nose fasteners 1326 and the vane fasteners 1214 pass through, respectively, bores 1328 and 1216 in the pedestal 1320 (see FIG. 32). Similar to the vane 194, all of the bores 1328 in the pedestal 1320 extend generally parallel to the vane-vertical direction 1198, and none of the bores 1328 extend through the pedestal 1320 in a generally circumferential direction. Accordingly, the nose fasteners 1326 are each oriented generally parallel to the vane-vertical direction 1198. In the subject embodiment, the bores 1328 for the nose fasteners 1326 are aligned with the pocket 1180 in the pedestal 1320, such that the nose fasteners 1326 are concealed within the pocket 1180 of the pedestal 1320 and within the nose 1322, when the nose 1322 is secured to the pedestal 1320 and the pedestal 1320 is secured to the hub 1170. Accordingly, the nose fasteners 1326 are not openly exposed to an environment surrounding the vane assembly 1106, such as the environment within the cavity of the casing of the snubber. In the subject embodiment, the nose fasteners 1326 and the vane fasteners 1214 are oppositely oriented, such that the nose fasteners 1326 are oriented upward in the vane-vertical direction 1198 and the vane fasteners 1214 are oriented downward in the vane-vertical direction 1198. Although fasteners have been described above, in other embodiments, the pedestal 1320 may be secured to the hub 1170 and/or the nose 1322 may be secured to the pedestal 1320 by dovetail joints, similar to the dovetail joint described above for the vane 194 and the hub 170.

The pedestal 1320 preferably reinforces the nose 1322. Accordingly, the nose facing surface 1324 of the pedestal 1320 comprises a nose reinforcing feature that is configured to reinforce the nose 1322, when the nose 1322 is secured to the pedestal 1320. In the subject embodiment, the nose reinforcing feature is a pedestal protrusion 1330. The pedestal protrusion 1330 extends radially outward from the nose facing surface 1324 of the pedestal 1320 and is sized to fit within a pocket 1332 in the nose 1322 (see FIG. 39). Preferably, the pedestal protrusion 1330 extends radially beyond a centroid of the nose when the nose 1322 is secured to the pedestal 1320. Having the nose reinforcing feature extend radially beyond the centroid of the nose can help the nose reinforcing feature resist forces on the nose 1322 during operation, which may improve longevity and/or performance of the snubber. In some embodiments, the nose reinforcing feature can comprise a nose key receiving pocket in the pedestal 1320 and a nose reinforcing key. The nose reinforcing key is sized to fit within the nose key receiving pocket, i.e., mates with the nose key receiving pocket, and extends from the nose key receiving pocket into the pocket 1332 in the nose 1322. Similar to the pedestal protrusion 1330, the nose reinforcing key can be sized to extend radially beyond the centroid of the nose, when the nose 1322 is secured to the pedestal 1320.

The nose 1322 is configured to be mounted to the pedestal 1320, as described above. The nose 1322 comprises a pedestal facing surface 1334 that is mounted to the pedestal 1320. The pedestal facing surface 1334 includes the pocket 1332 for receiving the pedestal protrusion 1330. A plurality of threaded holes 1336 are provided in the pocket 1332 for receiving the nose fasteners 1326. The nose 1322 is rounded and has a semi-circular shape. At least a portion of the vane channel 1258 is defined in an end region 1338 of the nose 1322. The end region 1338 of the nose 1322 comprises at least part of the distal portion 1148 of the outer surface 1174 of the vane assembly 1106. In the subject embodiment, the end region 1338 of the nose 1322 comprises the majority of the distal portion 1148 and the majority of the vane channel 1258. The end region 1338 of the nose 1322, including the portion of the vane channel 1258 therein, can be completely manufactured by an uninterrupted sequence of nose turning operations without removing the nose 1322 from a lathe performing the nose turning operations. That is, the end region 1338 of the nose 1322 may be entirely machined from circular bar-stock using a lathe. Put another way, the end region 1338 of the nose 1322 and the portion of the vane channel 1258 therein are entirely defined by a plurality of circular arcs that are all coaxial and are each defined at a respective axial position and radial depth, such that the arcs can all be completed by a lathe in a continuous operation. Thereafter, the pedestal facing surface 1334 and the pocket 1332 in the nose 1322 can be formed using milling and/or drilling operations. This limited sequence of operations for constructing the nose 1322 may reduce cost and/or simply manufacturing.

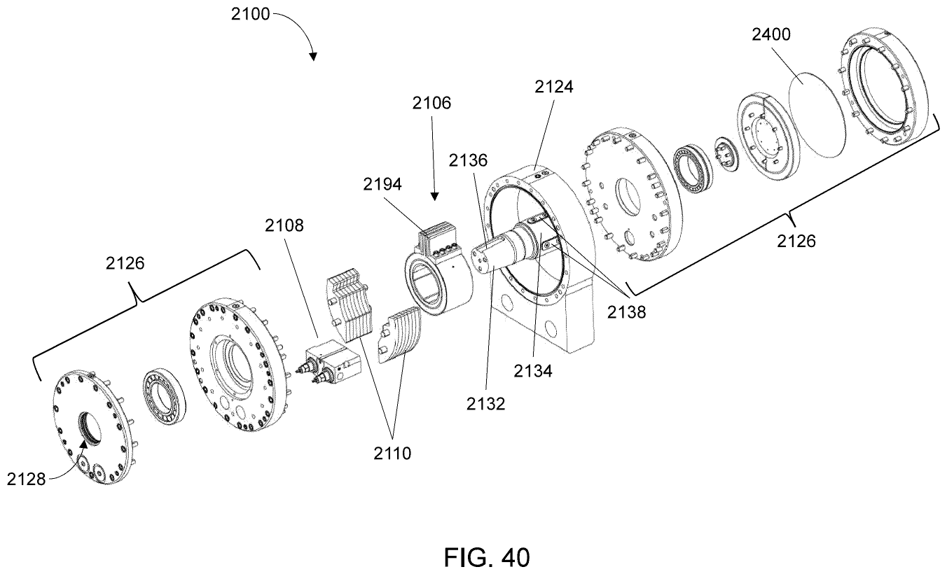

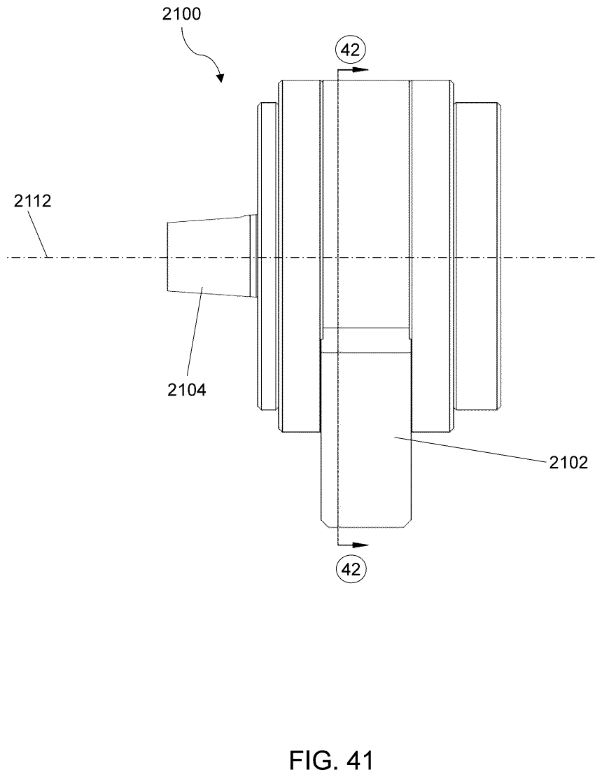

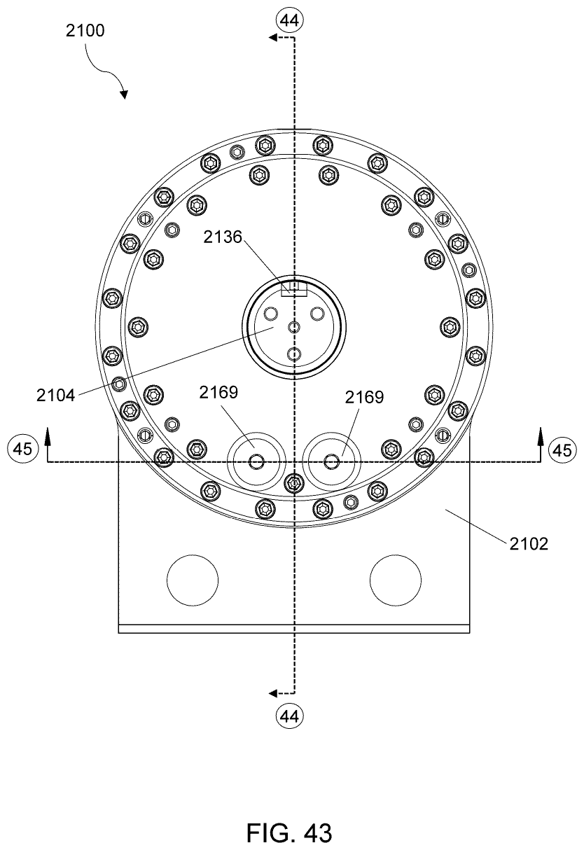

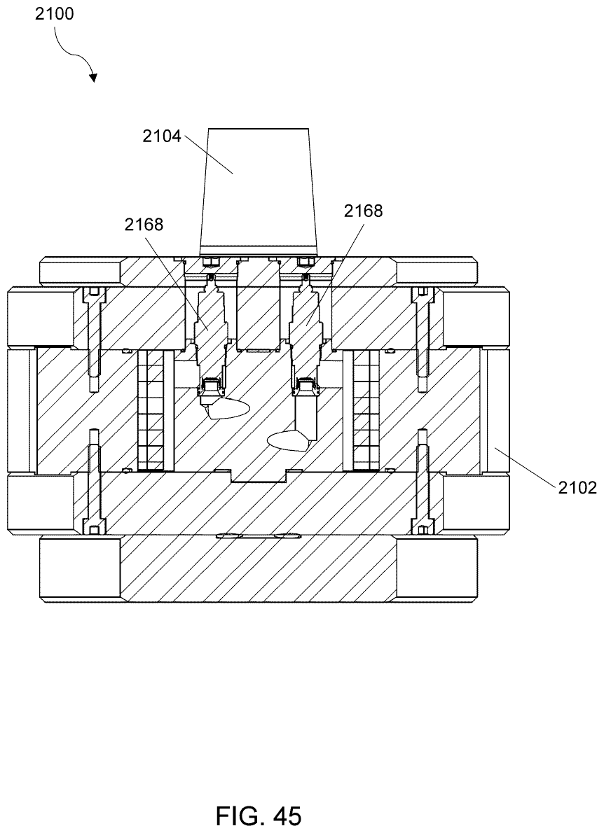

Turning to FIGS. 40 to 45, another embodiment of a snubber is shown and generally identified by reference character 2100. The snubber 2100 is generally similar to snubber 100, and like elements are identified with like reference numbers incremented by 2000. In the illustrated example, flow control devices 2166 are scavenge oil check valves, although it will be appreciated that other suitable flow control devices could be used.

Snubber 2100 includes an accumulator to help compensate for thermal expansion of fluid in the snubber 2100. In the illustrated example, the accumulator includes a flexible diaphragm. Alternatively, the accumulator could be configured as a piston-gas style accumulator, a piston-spring style accumulator, a bladder style accumulator, an “air over oil” accumulator, or any other suitable accumulator design.

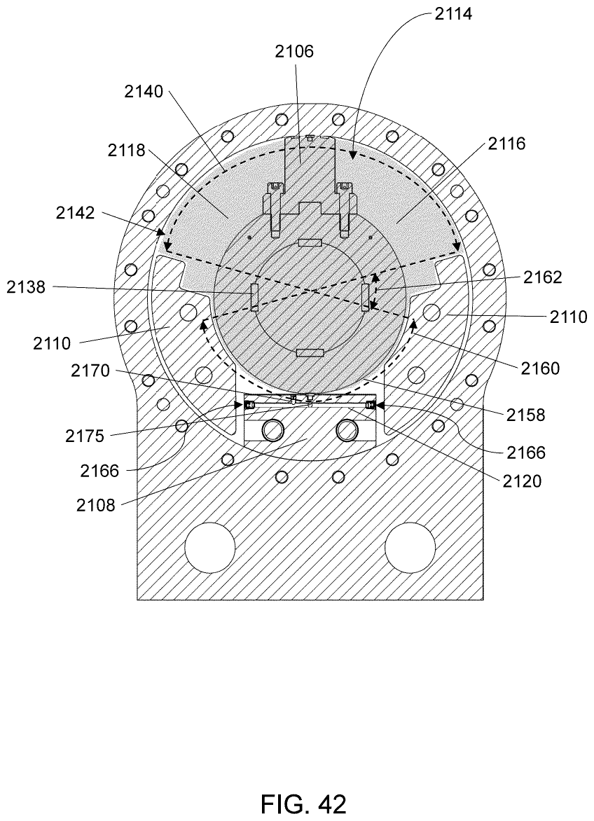

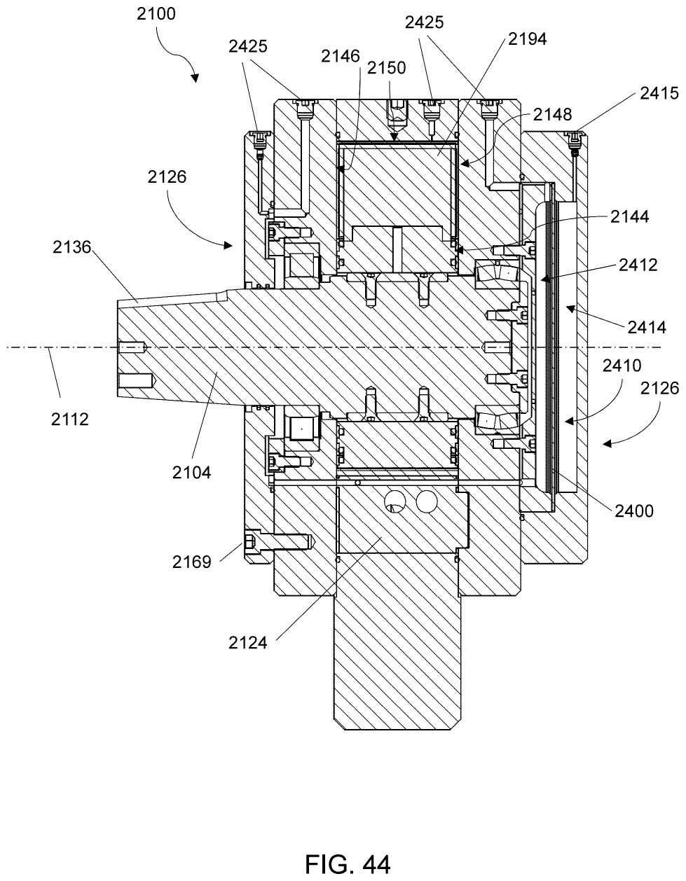

As perhaps best seen in FIG. 44, in the illustrated example snubber 2100 includes a flexible diaphragm 2400 positioned in and dividing an accumulator cavity 2410 into a liquid side 2412 and a gas side 2414. The liquid side 2412 of cavity 2410 is in fluid communication with internal cavity 2114 (e.g. via a flow path including check valve 2170, fluid control passage 2120, and orifice 2175 (see e.g. FIG. 42); a flow path including a flow control device 2166, fluid control passage 2120, and orifice 2175 (see e.g. FIG. 42); and/or leakage between the vane seals and the end assemblies 2126 (see e.g. FIG. 44), such that if liquid (e.g. oil) within casing 2102 expands in volume (e.g. as a result of being heated), excess liquid volume may be driven into cavity 2410. Also, if liquid within casing 2102 contracts in volume (e.g. as a result of being cooled, and/or due to fluid leaks from the casing), additional liquid volume may be supplied with internal cavity 2114 from accumulator cavity 2410. In the illustrated example, a liquid fluid (e.g. oil) may be introduced into casing 2102 via one or more liquid fill ports 2425. Diaphragm 2400 may be made from any suitable material, such as a low temperature nitrile.

In the illustrated example, the gas side 2414 of accumulator cavity 2410 is configured to be filled with a pressurized gas. For example, gas may be introduced via a gas fill port 2415. Suitable gases include air, Nitrogen, CO₂, and the like. In such an arrangement, expansion of the volume of the liquid side 2412 of cavity 2410 resulting from an axially outward deflection of diaphragm 2400 (e.g. due to an inflow of liquid to the liquid side 2412) may be resisted by a force required to further compress the volume of the gas side 2414 of cavity 2410, i.e., a force resisting axially outward deflection of diaphragm 2400. It will be appreciated that the expected force resisting axially outward deflection of diaphragm 2400 may be controlled by adjusting the volume and/or pressure of gas in the gas side 2414. In some embodiments, the gas pressure may be between about 10 to 150 psi, or about 15 to 80 psi.

Providing an accumulator to regulate the volume of a liquid side of the accumulator cavity may have one or more advantages. For example, such an arrangement may promote more predictable and/or consistent performance of snubber 2100 across a range of working fluid temperatures, as the accumulator may promote a consistent supply of pressurized liquid (e.g. oil) within internal cavity 2114.

Also, in the illustrated example, the accumulator system is housed completely within the overall physical envelope of the snubber 2100. For example, the accumulator cavity 2410 is housed within casing 2102, and more specifically within end assembly 1126. Also, in the illustrated example the snubber axis 2112 intersects the accumulator cavity 2410, and more particularly the centre of the accumulator cavity 2410. Providing an accumulator housed completely within casing 2102 may have one or more advantages. For example, such an arrangement may be characterized as a more compact design, and may eliminate the need to provide a snubber with a physically separate accumulator. Additionally, or alternatively, having the accumulator housed within the snubber may also protect the accumulator from damage. For example, a remote accumulator (and associated plumbing) would likely be more vulnerable to damage due to e.g. falling material.

Although embodiments have been described above and are shown in the accompanying drawings, it will be appreciated by those skilled in the art that variations and modifications may be made without departing from the scope defined by the appended claims, and the scope of the claims should be given the broadest interpretation consistent with the specification as a whole.

1. A vane assembly for a snubber, the vane assembly comprising:
a hub for mounting on a shaft of the snubber to rotate with the shaft about a snubber axis, the hub having an inner surface for mounting on the shaft and an outer surface with a vane mounting portion and a dam sealing portion;
a vane removably secured to the hub to rotate with the hub about the snubber axis, the vane extending from the hub in a vane-vertical direction and defining at least a distal portion of an outer contour of the vane assembly, the vane having a hub facing surface for mounting to the vane mounting portion of the hub; and
a seal assembly for providing a seal between a casing of the snubber and the vane assembly.

2. The vane assembly of claim 1, wherein the vane comprises a pedestal removably secured to the hub and a nose removably secured to the pedestal opposite the hub.

3-16. (canceled)

17. The vane assembly of claim 1, wherein the hub comprises a pressure conduit that extends from a pressure inlet to a pressure outlet in a seal channel of the hub, the pressure conduit allowing flow from the pressure inlet to the pressure outlet to pressurize at least a portion of the seal channel.

18. The vane assembly of claim 17, further comprising a conduit flow control device configured to restrict reverse flow in the pressure conduit from the pressure outlet to the pressure inlet.

19. The vane assembly of claim 18, wherein the conduit flow control device is a check valve provided along the pressure conduit between the pressure inlet and the pressure outlet.

20-54. (canceled)

55. A snubber comprising:
a casing having an internal cavity;
a shaft extending through the casing and into the internal cavity;
a vane assembly as defined in claim 1, wherein the vane assembly is secured on the shaft within the internal cavity to rotate with the shaft about the snubber axis and through a vane-swept region within the internal cavity, wherein the outer contour of the vane assembly generally corresponds to an inner contour of the internal cavity in the vane-swept region, and wherein the seal assembly provides a seal between the vane assembly and the casing; and
a dam secured to the casing within the internal cavity and engaging a dam sealing portion of the hub of the vane assembly, such that the dam and the vane assembly divide the internal cavity into a first pressure chamber and an opposing second pressure chamber, wherein a fluid control passage is provided between the first pressure chamber and the second pressure chamber, to control fluid flow between the first and second pressure chambers as the vane assembly rotates.

56. (canceled)

57. (canceled)

58. The snubber of claim 55, further comprising an accumulator in fluid communication with the fluid control passage and housed within the casing.

59. The snubber of claim 55, further comprising one or more displacement bodies secured within the internal cavity of the casing and positioned outside the vane-swept region to reduce an amount of fluid required to fill the first and second pressure chambers.

60-62. (canceled)

63. The snubber of claim 55, further comprising an accumulator in fluid communication with the internal cavity, the accumulator being housed completely within the casing.

64. A snubber comprising:
a casing having an internal cavity;
a shaft extending through the casing and into the internal cavity;
a vane assembly secured on the shaft within the internal cavity to rotate with the shaft about a snubber axis and through a vane-swept region within the internal cavity;
a dam secured to the casing within the internal cavity and engaging the vane assembly such that the dam and the vane assembly divide the internal cavity into a first pressure chamber and a second pressure chamber; and
an accumulator in fluid communication with the internal cavity, the accumulator housed completely within the casing.

65. The snubber of claim 64, wherein the accumulator comprises an accumulator cavity having a volume, and a flexible diaphragm separating the volume into a liquid side and a gas side.

66. The snubber of claim 65, wherein the gas side of the accumulator cavity volume is configured to hold compressed gas.

67-69. (canceled)

70. The snubber of claim 64, wherein the accumulator is in fluid communication with the internal cavity via a flow path that includes at least one flow control device.

71. The snubber of claim 70, wherein the at least one flow control device comprises a scavenge oil check valve.

72. A vane assembly for a snubber, the vane assembly comprising:
a hub for mounting on a shaft of the snubber to rotate with the shaft about a snubber axis, the hub having an inner surface for mounting on the shaft and an outer surface with a vane extending radially outwardly from the outer surface; and
a seal assembly for providing a seal between a casing of the snubber and the vane assembly.

73. The vane assembly of claim 72, wherein the hub comprises a pressure conduit that extends from a pressure inlet to a pressure outlet in a seal channel of the hub, the pressure conduit allowing flow from the pressure inlet to the pressure outlet to pressurize at least a portion of the seal channel.

74. The vane assembly of claim 73, further comprising a conduit flow control device configured to restrict reverse flow in the pressure conduit from the pressure outlet to the pressure inlet.

75-85. (canceled)

86. A snubber comprising:
a casing having an internal cavity;
a shaft extending through the casing and into the internal cavity;
the vane assembly of claim 72, wherein the vane assembly is secured on the shaft within the internal cavity to rotate with the shaft about the snubber axis and through a vane-swept region within the internal cavity, wherein an outer contour of the vane assembly generally corresponds to an inner contour of the internal cavity in the vane-swept region, and wherein the seal assembly provides a seal between the vane assembly and the casing; and
a dam secured to the casing within the internal cavity and engaging the dam sealing portion of the hub of the vane assembly, such that the dam and the vane assembly divide the internal cavity into a first pressure chamber and an opposing second pressure chamber,
wherein a fluid control passage is provided between the first pressure chamber and the second pressure chamber, to control fluid flow between the first and second pressure chambers as the vane assembly rotates.

87-92. (canceled)

93. The snubber of claim 58, further comprising one or more displacement bodies secured within the internal cavity of the casing and positioned outside the vane-swept region to reduce an amount of fluid required to fill the first and second pressure chambers.

94. The snubber of claim 58, wherein the accumulator is in fluid communication with the internal cavity.
